(19) United States
(12) Patent Application Publication
(10) Pub. No.: US 2024/0354584 A1
(43) Pub. Date: Oct. 24, 2024

(54) LANGUAGE MODEL-BASED TABULAR DATA OBJECT EXTRACTION AND VISUALIZATION

(71) Applicant: Palantir Technologies Inc., Denver, CO (US)

(72) Inventors: Anirvan Mukherjee, Brooklyn, NY (US); Craig De Souza, Jersey City, NJ (US); Edgar Gomes de Araujo, Sao Paulo (BR); Johannes Beil, Copenhagen (DK); Jessica Winssinger, New York, NY (US); Michael Zullo, Scarsdale, NY (US); Rushad Heerjee, New York, NY (US); Shubhankar Sachdev, New York, NY (US)

(21) Appl. No.: 18/632,958

(22) Filed: Apr. 11, 2024

Related U.S. Application Data
(60) Provisional application No. 63/497,933, filed on Apr. 24, 2023.
(60) Provisional application No. 63/589,894, filed on Oct. 12, 2023.
(60) Provisional application No. 63/497,930, filed on Apr. 24, 2023.
(60) Provisional application No. 63/589,911, filed on Oct. 12, 2023.

(51) Int. Cl. G06N 3/0895

(52) U.S. Cl. CPC G06N 3/0895

(57) ABSTRACT

Computer-implemented systems and methods are disclosed, including systems and methods utilizing language models for creating and/or updating an ontology. A computer-implemented method may include: receiving tabular data from one or more data sources; generating an interactive graphical representation of at least a portion of the tabular data and connections between the portion of the tabular data; providing, via a user interface, the interactive graphical representation; receiving a user operation via the user interface, updating an ontology and/or generating transformations for adding data objects into a database.

### CROSS-REFERENCE TO RELATED APPLICATIONS

This application claims benefit of U.S. Provisional Patent Application No. 63/497,933, filed Apr. 24, 2023, and titled “LANGUAGE MODEL-BASED DATA ONTOLOGY GENERATION,” U.S. Provisional Patent Application No. 63/497,930, filed Apr. 24, 2023, and titled “LANGUAGE MODEL-BASED DATA OBJECT EXTRACTION AND VISUALIZATION,” U.S. Provisional Patent Application No. 63/589,894, filed Oct. 12, 2023, and titled “LANGUAGE MODEL-BASED TABULAR DATA OBJECT EXTRACTION AND VISUALIZATION,” and U.S. Provisional Patent Application No. 63/589,911, filed Oct. 12, 2023, and titled “LANGUAGE MODEL-BASED DATA OBJECT EXTRACTION AND VISUALIZATION.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for utilizing computer-based models. More specifically, the present disclosure relates to computerized systems and techniques for creating or updating an ontology using tabular data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computers can be programmed to perform calculations and operations utilizing one or more computer-based models. For example, an ontology may be used by an organization to model a view of, or provide a template for, what objects exist in the world, what their properties are, and how they are related to each other.

### SUMMARY

The systems, methods, and devices described herein each have several aspects, no single one of which is solely responsible for its desirable attributes. Without limiting the scope of this disclosure, several non-limiting features will now be described briefly. For ease of discussion, certain implementations described herein relate to using an LLM-based tabular data processing pipeline and UI-based functionality for defining an ontology/set of transformations to convert the tabular data to data objects.

The present disclosure relates to systems and methods (generally collectively referred to herein as “a data extraction system” or simply a “system”) that can advantageously utilize machine learning, natural language processing, and/or interactive visualization techniques to enable users to more efficiently create or update an ontology based on disparate data across multiple tables. For example, the system can employ one or more large language models (“LLMs”) and data analysis techniques to identify relationships between columns of the same or different tables and provide an interactive graphical representation of columns of tables and relationships among columns of the same or different tables. By performing various operations (e.g., select, drag, move, group, or the like) on the nodes or edges of the interactive graphical representation, users may more efficiently create the ontology based on columns of tables that are useful for their needs. Further, the system can define the ontology users intend to create or update using one or more transformations that transform columns of tables selected by users for creating the ontology and data objects, where the one or more transformations can be stored in database(s) of the system as code that specifies the one or more transformations.

Various implementations of the present disclosure provide improvements to various technologies and technological fields. For example, as described above, the system may advantageously use UI-based functionality for defining an ontology/set of transformations to convert the tabular data to data objects, thereby reducing time and labor required for creating and/or updating the ontology using tabular data. Other technical benefits provided by various implementations of the present disclosure include, for example, utilizing an LLM-based tabular data processing pipeline that employs one or more LLMs to efficiently identify relationships between columns of tables, thereby assisting users to create and/or update an ontology based on with reference to identified relationships between columns of tables.

Additionally, various implementations of the present disclosure are inextricably tied to computer technology. In particular, various implementations rely on detection of user inputs via graphical user interfaces, calculation of updates to displayed electronic data based on those user inputs, automatic processing of related electronic data, application of language models and/or other artificial intelligence, and presentation of the updates to displayed information via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various implementations cannot reasonably be performed by humans alone, without the computer technology upon which they are implemented. Further, the implementation of the various implementations of the present disclosure via computer technology enables many of the advantages described herein, including more efficient interaction with, and presentation of, various types of electronic data.

According to various implementations, large amounts of data are automatically and dynamically calculated interactively in response to user inputs, and the calculated data is efficiently and compactly presented to a user by the system. Thus, in some implementations, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The present disclosure describes various implementations of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface via the inputs described herein may provide an optimized display of, and interaction with, models and model-related data, and may enable a user to more quickly and accurately access, navigate, assess, and digest the model-related data than previous systems.

Further, the interactive and dynamic user interfaces described herein are enabled by innovations in efficient interactions between the user interfaces and underlying systems and components. For example, disclosed herein are improved methods for utilizing machine learning, natural language processing, and/or interactive visualization techniques to enable users to more efficiently create or update an ontology based on disparate data across multiple tables. According to various implementations, the system (and related processes, functionality, and interactive graphical user interfaces), can advantageously employ one or more large language models (“LLMs”) and data analysis techniques to identify relationships between columns of the same or different tables and provide an interactive graphical representation of columns of tables and relationships among columns of the same or different tables. By performing various operations (e.g., select, drag, move, group, or the like) on the nodes or edges of the interactive graphical representation, users may more efficiently create the ontology based on columns of tables that are useful for their needs. Further, the system can define the ontology users intend to create or update using one or more transformations that transform columns of tables selected by users for creating the ontology, where the one or more transformations can be stored in database(s) of the system as code that specifies the one or more transformations.

Thus, various implementations of the present disclosure can provide improvements to various technologies and technological fields, and practical applications of various technological features and advancements. For example, as described above, existing computer-based model management and integration technology is limited in various ways, and various implementations of the disclosure provide significant technical improvements over such technology. Additionally, various implementations of the present disclosure are inextricably tied to computer technology. In particular, various implementations rely on operation of technical computer systems and electronic data stores, automatic processing of electronic data, and the like. Such features and others (e.g., processing and analysis of large amounts of electronic data, management of data migrations and integrations, and/or the like) are intimately tied to, and enabled by, computer technology, and would not exist except for computer technology. For example, the interactions with, and management of, computer-based models described below in reference to various implementations cannot reasonably be performed by humans alone, without the computer technology upon which they are implemented. Further, the implementation of the various implementations of the present disclosure via computer technology enables many of the advantages described herein, including more efficient management of various types of electronic data (including computer-based models).

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums having program instructions embodied therewith, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums are disclosed, wherein the computer-readable storage medium(s) have program instructions embodied therewith, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a schematic block diagram illustrating an example data extraction system in an example computing environment, according to various implementations of the present disclosure;

FIG. 2 depicts a block diagram of the data extraction system, according to various implementations of the present disclosure;

FIG. 3 illustrates an example object-centric conceptual data model, according to various implementations of the present disclosure;

FIG. 4 illustrates an example graphical representation of data objects and links in the object-centric conceptual data model of FIG. 3;

FIG. 5 is a flowchart depicting an example method for creating and/or updating an ontology based on tabular data, according to various implementations of the present disclosure;

FIG. 6 is a flowchart depicting an example method for defining data object type(s) and/or link type(s) based on one or more user operations, according to various implementations of the present disclosure;

FIGS. 7, 8, and 9 are illustrations of example user interfaces of the data extraction system, according to various implementations of the present disclosure;

FIG. 10 depicts a flowchart showing an example method for applying an ontology and/or transformation to tabular data to add data objects to a database, according to various implementations of the present disclosure;

FIGS. 11A-11D show an example flow for adding data objects into a database associated with an ontology based on one or more user operations to node(s) of an interactive graphical representation that represent columns of tabular data, according to various implementations of the present disclosure; and

FIG. 12 is a block diagram of an example computer system consistent with various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

An ontology may be used to model a view of, or provide a template for, what objects exist in the world, what their properties are, and how they are related to each other. Once created, an ontology may need to be updated or expanded to meet evolving needs of, for example, an organization to process new knowledge. However, creation or update of an ontology based on tabular data may entail complex processes. For example, there may not be any efficient or more automated techniques for creating an ontology from portions of tabular data. Specifically, it may be difficult to identify relationships between columns across disparate data tables for creating a customized ontology based on portions of tables that are related to each other. Further, processing tabular information for creating or updating an ontology may be even more challenging as the number or size of tables increases.

As noted above, the present disclosure describes examples of a data extraction system (or simply a “system”) that can advantageously overcome various of the technical challenges mentioned above, among other technical challenges. For example, various implementations of the systems and methods of the present disclosure can advantageously utilize machine learning, natural language processing, and/or interactive visualization techniques to enable users to more efficiently create or update an ontology based on disparate data across multiple tables. For example, the system can employ one or more large language models (“LLMs”) and data analysis techniques to identify relationships between columns of the same or different tables and provide an interactive graphical representation of columns of tables and relationships among columns of the same or different tables. By performing various operations (e.g., select, drag, move, group, or the like) on the nodes or edges of the interactive graphical representation, users may more efficiently create the ontology based on columns of tables that are useful for their needs. Further, the system can define the ontology users intend to create or update using one or more transformations that transform columns of tables selected by users for creating the ontology, where the one or more transformations can be stored in database(s) of the system as code that specifies the one or more transformations.

More specifically, the system may receive tabular data from one or more data sources, where the tabular data may include at least a first table that has a first plurality of columns and a second table that has a second plurality of columns. The system may then generate a first prompt for a LLM, where the first prompt may include at least a portion (e.g., name of the first table, names of the first plurality of columns, or other information contained in the first table) of the first table and at least a portion (e.g., name of the second table, names of the second plurality of columns, or other information contained in the second table) of the second table. The system may transmit the first prompt to the LLM and receive a first output from the LLM in response to the first prompt, where the first output may include at least a first connection between a first column of the first plurality of columns and a first column of the second plurality of columns. The first connection may be identified by the LLM and may indicate the first column of the first plurality of columns and the first column of the second plurality of columns are related to (e.g., having similar column names, having similar contents in entries, or having other similar information) each other. The system may further provide, via a user interface, an interactive graphical representation including at least a first node representing a name of the first column of the first plurality of columns, a second node representing a name of the first column of the second plurality of columns, and a first edge connecting the first node and the second node, the first edge representing the first connection that is included in the first output from the LLM. Based at least in part on receiving a user operation made via the interactive graphical representation to at least the first node, the system may create and/or update an ontology to include a first data object type corresponding to the name of the first column of the first plurality of columns.

As such, the system can streamline the process of creating and/or updating an ontology based on tabular data through automated techniques that utilize LLMs and interactive graphical representation for creating and/or updating an ontology from portions of tabular data that users are interested in. Further, by employing one or more LLMs for processing tabular information, the system may more efficiently identify relationships between columns across disparate data tables for creating a customized ontology based on portions of tables that are related to each other. Additionally, the system can define the ontology users intend to create or update using one or more transformations that transform columns of tables selected by users for creating the ontology, where the one or more transformations can be stored in database(s) of the system as code that specifies the one or more transformations. As such, users can flexibly and quickly create or update an ontology at various desired timing, for example, by executing the code that specifies the one or more transformations generated based on user operations to the interactive graphical representation.

### Example Aspects Related to Processing Tabular Information Using LLMs

The system can utilize one or more LLMs and data analysis techniques to identify relationships between columns of different tables. Specifically, a table may include information specifying relationships between its columns but may not include information specifying relationships between its columns and columns of another table. The system may nevertheless employ one or more LLMs to search and identify relationships between columns of different tables through various data processing techniques, such as vectorization and/or similarity search based at least on names of the tables or names of columns of different tables. The relationships among columns of the same or different tables may then be presented by the system through interactive graphical user interface(s). Advantageously, the identified relationships allow users to efficiently observe connections among data from disparate sources for creating an ontology based on the need of users.

For example, the system may receive tabular data from one or more data sources, where the tabular data may include at least a first table that has a first plurality of columns and a second table that has a second plurality of columns. The system may then generate a first prompt for a LLM, where the first prompt may include at least a portion (e.g., name of the first table, names of the first plurality of columns, or other information contained in the first table) of the first table and at least a portion (e.g., name of the second table, names of the second plurality of columns, or other information contained in the second table) of the second table. The system may transmit the first prompt to the LLM and receive a first output from the LLM in response to the first prompt, where the first output may include at least a first connection between a first column of the first plurality of columns and a first column of the second plurality of columns. The first connection may be identified by the LLM and may indicate the first column of the first plurality of columns and the first column of the second plurality of columns are related to (e.g., having similar column names, having similar contents in entries, or having other similar information) each other.

To identify the first connection that may indicate certain relationships between the first column of the first plurality of columns and the first column of the second plurality of columns, the LLM or the system may utilize various data processing techniques such as vectorization and similarity search. For example, the LLM may vectorize the first column of the first plurality of columns into a first vector, and vectorize the first column of the second plurality of columns into a second vector. The LLM may then execute, using at least the first vector and the second vector, a similarity search to establish the first connection between the first column of the first plurality of columns and the first column of the second plurality of columns are related to each other. The LLM may execute the similarity search using one of the cosine similarity search, approximate nearing neighbor (ANN) algorithms, k nearest neighbors (KNN) method, locality sensitive hashing (LSH), range queries, or any other vector clustering and/or similarity search algorithms. For example, the LLM may vectorize names of the first column of the first plurality of columns and first column of the second plurality of columns and/or vectorize contents in the entries of the first column of the first plurality of columns and first column of the second plurality of columns. The LLM may then execute the similarity search to identify if the names and/or contents of the first column of the first plurality of columns and first column of the second plurality of columns are similar or related.

The relationship between the first column of the first plurality of columns and first column of the second plurality of columns along with other relationships between columns of the same table may then be presented by the system through interactive graphical user interface(s). Advantageously, the relationships identified by the LLM as well as relationships between columns of a table that may be included in the table may allow users to efficiently observe connections among data from disparate sources for creating an ontology based on the need of users.

Example Aspects of Visualizing Tabular Information for Creating and/or Updating an Ontology

The system can provide an interactive graphical representation of columns of tables and relationships among columns of tables. For example, the interactive graphical representation may include a graph-based visualization that include a plurality of nodes and a plurality of edges, where the nodes may represent names of columns of tables and/or the edges may represent relationships between columns of tables. By performing various operations (e.g., select, drag, move, group, or the like) on the nodes or edges of the graph-based visualization, users may more efficiently create an ontology to define data object types, properties, or link types based on names of columns or relationships between columns for enriching knowledge base of an organization in line with objective of the organization. Based on data object types defined in the ontology, the system may further automatically generate data objects using contents within columns of tables.

In various implementations, the system may provide, via a user interface, an interactive graphical representation including at least a first node representing a name of a first column of a first plurality of columns of a first table, a second node representing a name of a first column of a second plurality of columns of a second table, and a first edge connecting the first node and the second node, the first edge representing a first connection between the first column of the first plurality of columns of the first table and the first column of the second plurality of columns of the second table. Based at least in part on receiving a first user operation made via the interactive graphical representation to at least the first node, the system may create and/or update an ontology to include a first data object type corresponding to the name of the first column of the first plurality of columns.

For example, the first user operation may indicate that the name of the first column of the first plurality of columns represented by the first node is to be defined in the ontology as the first data object type. In response to receiving the first user operation, the system may update the ontology to define the first data object type in the ontology. Based at least in part on updating the ontology to include the first data object type, the system may further optionally add into one or more databases associated with the ontology a plurality of first data objects of the first data object type, where the plurality of first data objects may represent entries of the first column of the first plurality of columns.

In addition to visualizing the first node and the second node, the system may further provide a third node via the interactive graphical representation to represent a name of a second column of the first plurality of columns. In response to receiving a second user operation, made via the interactive graphical representation, that associates the third node with the second node, the system may update the ontology to include a second data object type corresponding to the name (e.g., client) of the first column of the second plurality of columns, and a first property type of the second data object type based on the name (e.g., birthday) of the second column of the first plurality of columns represented by the third node. As such, the system may provide users the flexibility to create and/or update an ontology by adding a data object type using one column of a table and adding a property type of the data object type using another column of the table or another table.

Additionally, the system may further provide users the flexibility to update an ontology by changing a property type of a data object type to another data object type, thereby allowing users to efficiently switching between data object types and property types using columns of tables. For example, the system may further receive a third user operation, via the interactive graphical representation, that disassociates the third node with the second node. Based at least in part on receiving the third user operation, the system may update the ontology to include the second data object type corresponding to the name of the first column of the second plurality of columns without the first property type of the second data object type, and to also include a third data object type corresponding to the name of the second column of the first plurality of columns.

The system may also provide users the flexibility to create and/or update an ontology to include a data object type corresponding to an entity type that may be defined by a user, where the entity type may have property types that are generated based on columns of tables. For example, the system may receive a fourth user operation, via the interactive graphical representation that includes at least the first node, the second node, and the third node, that associates the third node and the second node with a first entity type that is defined by a user, where the fourth user operation indicates that the user intends to create a data object type that has property types based on the names of the first column of the second plurality of columns and the second column of the first plurality of columns. Based at least in part on receiving the fourth user operation, the system may create and/or update the ontology to include at least: (i) a fourth data object type corresponding to the first entity type that is defined by the user, (ii) a first property type of the fourth data object type based on the name of the first column of the second plurality of columns represented by the second node, and (iii) a second property type of the fourth data object type based on the name of the second column of the first plurality of columns represented by the third node. Additionally and/or optionally, based on the created and/or updated ontology, the system may further add into one or more databases a plurality of fourth data objects of the fourth data object type. Specifically, one of the plurality of fourth data objects may have a first property of the first property type representing an entry of the first column of the second plurality of columns, and a second property of the second property type representing an entry of the second column of the first plurality of columns. In various implementations, the system may generate the plurality of fourth data objects of the fourth data object type based on one or more rules defined by the user, where the one or more rules may instruct the system how and/or which entries of columns are utilized to generate data objects. As such, the user may efficiently customize an ontology and convert tabular data to data objects of data object types defined by the ontology.

In addition to creating and/or updating an ontology through graph-based visualization, the system may further visualize an existing ontology using an interactive graphical representation of the user interface. For example, the system may provide a fourth node, via the interactive graphical representation of the user interface, that represents an entity type corresponding to a data object type that has been defined in the ontology. Advantageously, users may better understand what already exists in an ontology through visualization.

In various implementations, the system may further provide an interactive graphical representation to visualize relationship(s) between columns of a table, where information regarding the relationship(s) may be contained in the table. For example, the interactive graphical representation may include a fifth node, a sixth node, and a second edge connecting the fifth node and the sixth node, where the fifth node represents a name of a third column of the first plurality of columns of the first table, the sixth node represents a name of a fourth column of the first plurality of columns of the first table, the second edge represents a second connection between the third column of the first plurality of columns of the first table and the fourth column of the first plurality of columns of the first table, and information contained in the first table is indicative of the second connection. Advantageously, users may better understand relationships between columns of the same table and may utilize relationships between columns of the same table and/or different tables to create and/or update an ontology that is consistent with the needs of an organization.

In various implementations, the system may receive tabular data that includes at least a plurality of tables, and may provide an interactive graphical representation that includes at least a plurality sets of nodes, where each of the plurality sets of nodes corresponds to each of the plurality of tables. The interactive graphical representation may present nodes in manners that users can more easily observe. For example, the interactive graphical representation may represent nodes of each respective set of nodes to be visually similar (e.g., coated with the same color), and represent nodes of different sets of nodes to be visually distinctive (e.g., coated with different colors).

Example Aspects Related to Creating and/or Updating an Ontology Through Transformation

Once a user performs operations on the nodes or edges of the graph-based visualization, the system can define the ontology the user intends to create or update using one or more transformations that transform columns of tables selected by users for creating the ontology, where the one or more transformations can be stored in database(s) of the system as code that specifies the one or more transformations. When the user triggers the one or more transformations (e.g., through the graphical interactive representation), the system may execute the code to transform columns of tables selected by the user to the ontology the user intends to create or update. In addition to creating or updating an ontology, the one or more transformations, when triggered, may generate data objects of data object types defined in the ontology based on one or more rules defined by the user.

For example, in response to one or more user operations (e.g., select, drag, move, group, or the like) on nodes or edges that represent names of columns of tables or relationships between columns of tables, the system may generate code to specify a transformation for defining an ontology that the one or more user operations intend to create using names and/or relationships of the columns of tables. Upon receiving a triggering operation of the transformation, the system may execute the code to apply the ontology to tabular data to generate one or more data objects and/or links between the one or more data objects and store the one or more data objects and/or links into a database associated with the system. Advantageously, the transformation specified by the code enables the user to efficiently convert, at various desired timing, tabular data to data objects of data object types defined in an ontology, where the ontology is created and/or updated based on user operations on interactive graphical representations.

### Example Features Related to Entities, Data Objects and Ontology

The system may employ database(s) that uses an ontology and data objects to store, represent and/or organize data utilized by the system. The system may update an ontology to include new data object types or add data objects into one or more databases associated with an ontology to enrich the ontology, databases and/or knowledge bases of an organization. As such, data utilized by the system may be organized and linked to relevant context for providing a comprehensive knowledge base for auditing, reference, and analysis.

In various implementations, a body of data may be conceptually structured according to an object-centric data model represented by the ontology. The ontology may include stored information providing a data model for storage of data in the database. The ontology may be defined by one or more data object types, which may each be associated with one or more property types. At the highest level of abstraction, a data object of a data object type may be a container for information representing things in the world. For example, a data object can represent a document or other unstructured data source such as an e-mail message, a news report, or a written paper or article. Additionally, a data object can represent an entity such as a person, a place, an organization, a market instrument, or other noun. Data objects can further represent an event that happens at a point in time or for a duration. Each data object may be associated with a unique identifier that uniquely identifies the data object within the database of the system.

In various implementations, the system may create and/or update an ontology to include data object type(s) based on received tabular data. For example, the system may create an ontology to define data object types that correspond to entity types that may be defined by users. The system may further employ one or more LLMs to identify relationships between columns of tables of the tabular data, and create and/or update the ontology to include link types corresponding to identified relationships. The system may further generate data objects of data object types defined in the ontology in response to one or more transformations being triggered.

### Example Large Language Model-Related Functionality

The system may employ one or more LLMs to provide various services. For example, the system may utilize one or more LLMs to identify relationships between columns of tables, vectorize names and/or entries of columns of tables, execute similarity search to identify columns of tables that are related. In various implementations, the LLMs utilized by the system may be locally hosted, cloud managed, accessed via one or more Application Programming Interfaces (“APIs”), and/or any combination of the foregoing and/or the like. Data that may be processed and/or extracted using the LLMs may include any type of electronic data, such as text, files, documents, books, manuals, emails, images, audio, video, databases, web pages, time series data, and/or any combination of the foregoing and/or the like.

Additionally, the system may provide the flexibility of easily swapping between various language models employed by the system to provide various services. For example, the system may swap the LLM (e.g., switching between GPT-2 to GPT-3) for identifying relationships between columns of tables. Such model swapping flexibility provided by the system may be beneficial in various aspects, such as experimentation and adaptation to different models based on specific use cases or requirements, providing versatility and scalability associated with services rendered by the system.

In other implementations, the system can incorporate and/or communicate with one or more LLMs to perform various functions, such as vectorizing, executing similarity search on data. The communication between the system and the one or more LLMs may include, for example, a context associated with an aspect or analysis being performed by the system, a user-generated prompt, an engineered prompt, prompt and response examples, example or actual data, and/or the like. For example, the system may employ an LLM, via providing a prompt (e.g., a prompt that includes at least portions of one or more tables) to, and receiving an output (e.g., relationships between columns of the one or more tables) from, the LLM. The output from the LLM may be parsed and/or a format of the output may be updated to be usable for various aspects of the system.

### Further Example Information Related to Various Implementations

To facilitate an understanding of the systems and methods discussed herein, several terms are described below and herein. These terms, as well as other terms used herein, should be construed to include the provided descriptions, the ordinary and customary meanings of the terms, and/or any other implied meaning for the respective terms, wherein such construction is consistent with context of the term. Thus, the descriptions below and herein do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like. A “nondeterministic model” as used in the present disclosure, is any model in which the output of the model is not determined solely based on an input to the model. Examples of nondeterministic models include language models such as LLMs, ML models, and the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, attention-based and/or transformer architecture or functionality. LLMs can be useful for natural language processing, including receiving natural language prompts and providing natural language responses based on the text on which the model is trained. LLMs may not be data security- or data permissions-aware, however, because they generally do not retain permissions information associated with the text upon which they are trained. Thus, responses provided by LLMs are typically not limited to any particular permissions-based portion of the model.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, language model, or LLM, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), and BigScience Large Open-science Open-access Multilingual Language Model (BLOOM).

A Prompt (or “Natural Language Prompt” or “Model Input”) can be, for example, a term, phrase, question, and/or statement written in a human language (e.g., English, Chinese, Spanish, and/or the like), and/or other text string, that may serve as a starting point for a language model and/or other language processing. A prompt may include only a user input or may be generated based on a user input, such as by a prompt generation module (e.g., of a document search system) that supplements a user input with instructions, examples, and/or information that may improve the effectiveness (e.g., accuracy and/or relevance) of an output from the language model. A prompt may be provided to an LLM which the LLM can use to generate a response (or “model output”).

A User Operation (or “User Input”) can be any operations performed by one or more users to user interface(s) associated with a system (e.g., a data extraction system), where the operations may be performed by a user or on behalf of a user through a keyboard, mouse, touchscreen, voice recognition, and/or other input device. User operations can include select, drag, move, group, or the like, nodes or edges of one or more interactive graphical representations for updating an ontology based on unmatched classified triples represented by the nodes or the edges. User operations can include select an unmatched triple displayed in a list and identify one or more issues associated with the unmatched triple. User operations (e.g., input a text data to the data extraction system) can also prompt a task to be performed, such as by an LLM, in whole or in part.

An Ontology can include stored information that provides a data model for storage of data in one or more databases and/or other data stores. For example, the stored data may include definitions for data object types and respective associated property types. An ontology may also include respective link types/definitions associated with data object types, which may include indications of how data object types may be related to one another. An ontology may also include respective actions associated with data object types or data object instances. The actions may include defined changes to values of properties based on various inputs. An ontology may also include respective functions, or indications of associated functions, associated with data object types, which functions may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types. An ontology may be used by an organization to model a view of, or provide a template for, what objects exist in the world, what their properties are, and how they are related to each other.

A Data Object (or “Object” or “Data Object Instance”) is a data container for information representing a specific thing in the world that has a number of definable properties. For example, a data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object's attributes (also referred to as “contents”) may be represented in one or more properties. Attributes may include, for example, metadata about an object, such as a geographic location associated with the item, a value associated with the item, a probability associated with the item, an event associated with the item, and so forth. A data object may be of a data object type, where the data object is stored in a database that is associated with an ontology that defines the data object type.

A Data Object Type (or “Object Type”) is a type of a data object (e.g., person, event, document, and/or the like). Data object types may be defined by an ontology and may be modified or updated to include additional object types. A data object definition (e.g., in an ontology) may include how the data object is related to other data objects, such as being a sub-data object type of another data object type (e.g., an agent may be a sub-data object type of a person data object type), and the properties the data object type may have.

An Entity is or can refer to a specific person, institution, organization, place, market instrument, event, date, or other noun. Entities can be found in text data such as documents, emails, articles, news reports, written papers, any natural language texts, or the like. Entities can also be found in data triples that are extracted from text data. For example, a data triple may include a person entity (e.g., Mary), a place entity (e.g., country A), and a relationship (e.g., dwells) between the person entity and the place entity. An entity can be represented by a data object of a data object type, where the data object is stored in a database associated with an ontology that defines the data object type.

An Entity Type is a type of an entity. Entity types may include person entity type, place entity type, event entity type, date entity type, or the like. A plurality of entities can be of an entity type. For example, each of the entities Mary, John, Sam, Lenny, Jim, Alice, and Bob can be of the same entity type (e.g., a person entity type, or simply a “person”). An entity type may match a data object type defined in an ontology or may not match any data object type defined in the ontology.

A Data Store is any computer-readable storage medium and/or device (or collection of data storage mediums and/or devices). Examples of data stores include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. Another example of a data store is a hosted storage environment that includes a collection of physical data storage devices that may be remotely accessible and may be rapidly provisioned as needed (commonly referred to as “cloud” storage). According to various implementations, any data storage, data stores, databases, and/or the like described in the present disclosure may, in various implementations, be replaced by appropriate alternative data storage, data stores, databases, and/or the like.

A Database is any data structure (and/or combinations of multiple data structures) for storing and/or organizing data, including, but not limited to, relational databases (e.g., Oracle databases, PostgreSQL databases, MySQL databases, and the like), non-relational databases (e.g., NoSQL databases, and the like), in-memory databases, spreadsheets, comma separated values (CSV) files, extensible markup language (XML) files, TEXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) can be understood as being stored in one or more data stores. Additionally, although the present disclosure may show or describe data as being stored in combined or separate databases, in various implementations such data may be combined and/or separated in any appropriate way into one or more databases, one or more tables of one or more databases, and/or the like. According to various implementations, any database(s) described in the present disclosure may be replaced by appropriate data store(s). Further, data source(s) of the present disclosure may include one or more databases, one or more tables, one or more data sources, and/or the like, for example.

### Example System and Related Computing Environment

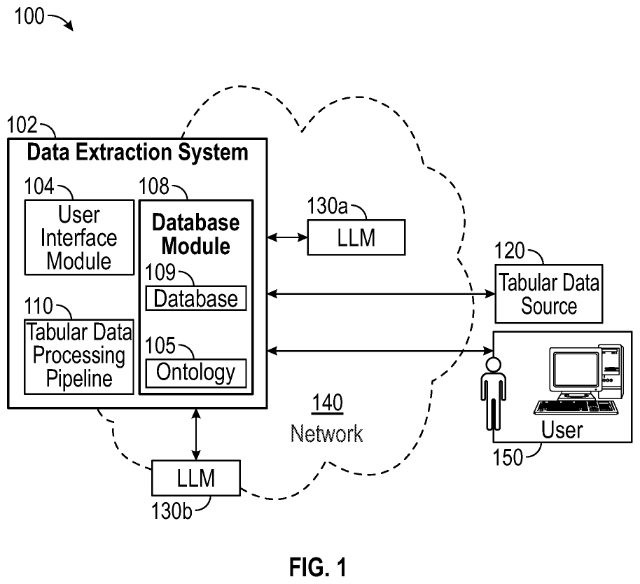

FIG. 1 illustrates an example computing environment 100 including an example data extraction system 102 that utilizes an LLM-based tabular data processing pipeline and UI-based functionality for defining an ontology/set of transformations to convert tabular data to data objects, according to various implementations of the present disclosure. The example computing environment 100 includes the data extraction system 102, one or more LLMs (e.g., an LLM 130a and/or, an LLM 130b), a network 140, a tabular data source 120, and a user 150 (and/or user computing device). In the example of FIG. 1, the data extraction system 102 comprises various modules, including a user interface module 104, a tabular data processing pipeline 110, a database module 108 that includes an ontology 105 and database 109. In other implementations, the data extraction system 102 may include fewer or additional components.

In the example of FIG. 1, the various devices are in communication via a network 140, which may include any combination of networks, such as one or more local area network (LAN), personal area network (PAN), wide area network (WAN), the Internet, and/or any other communication network. In various implementations, modules of the illustrated components, such as the user interface module 104, the tabular data processing pipeline 110, and the database module 108 of the data extraction system 102, may communicate via an internal bus and/or via the network 140.

The user interface module 104 is configured to generate user interface data that may be rendered on a user 150, such as to receive an initial user operation/input, as well as later user operation/input that may be used to initiate further data processing. In various implementations, the functionality discussed with reference to the user interface module 104, and/or any other user interface functionality discussed herein, may be performed by a device or service outside of the data extraction system 102 and/or the user interface module 104 may be outside the data extraction system 102. In various examples, the user 150 may perform various operations through the user interface module 104, such as selecting, dragging, moving, grouping, or the like, nodes or edges of one or more interactive graphical representations presented to the user 150 through the user interface module 104. Example user interfaces are described in greater detail below.

The tabular data processing pipeline 110 is configured to create and/or update the ontology 105, or add data objects into the database 109 associated with the ontology 105 based on tabular data received from the tabular data source 120. The tabular data processing pipeline 110 may receive tabular data from the tabular data source 120 and employ the LLM 130a or the LLM 130b to extract information and identify relationship among columns of tables in the tabular data for creating and/or updating the ontology 105 using the tabular data.

The database module 108 may be any types of data stores and can store any data objects of data object types defined by the ontology 105, which may define data object types and associated properties, and relationships among data object types, properties, and/or the like, that are created and/or updated based on tabular data from the tabular data source 120. The database module 108 is configured to store data/information that may be utilized by the tabular data processing pipeline 110 and/or accessed or manipulated by the user 150, as described herein. Data that may be stored in the database module 108 may include any type of electronic data, such as text, files, documents, books, manuals, emails, images, audio, video, databases, metadata, positional data (e.g., geo-coordinates), sensor data, web pages, time series data, and/or any combination of the foregoing and/or the like. The database module 108 may optionally obtain and store at least a portion of tabular data from the tabular data source 120.

Specifically, the database module 108 may store the ontology 105 and the database 109. The ontology 105 may constitute a way to represent things in the world. The ontology 105 may be used by an organization to model a view on what objects exist in the world, what their properties are, and how they are related to each other. The ontology 105 may be user-defined, computer-defined, or some combination of the two. The ontology 105 may include hierarchical relationships among data object types. The database 109 may store data objects of data object types that are defined by the ontology 105, which may be created based on user operations on tabular data received from the tabular data source 120.

The tabular data source 120 is configured to store tabular data that may be queried by the user 150 and/or various aspects of the data extraction system 102, where the stored tabular data may be obtained by the data extraction system 102. The tabular data source 120 may be a third-party or data source external to the data extraction system 102.

The data extraction system 102 may include and/or have access to one or more large language models or other language models (e.g., LLM 130a and LLM 130b), and the LLM may be fine-tuned or trained on appropriate training data. After receiving tabular data from the tabular data source 120, the data extraction system 102 may generate and provide a prompt to a LLM 130a and/or 130b, which may include one or more large language models trained to fulfill a modeling objective, such as identifying relationships between columns of tables in the tabular data.

As shown in FIG. 1, the data extraction system 102 may be capable of interfacing with multiple LLMs. This allows for experimentation, hot-swapping and/or adaptation to different models based on specific use cases or requirements, providing versatility and scalability to the system. In various implementations, the data extraction system 102 may interface with a second LLM 130b in order to, for example, generate classified triples based on data triples generated by the first LLM 130a. Although FIG. 1 illustrates that the LLM 130a and the LLM 130b are external to the data extraction system 102, in various implementations the LLM 130a and/or the LLM 130b can be internal to the data extraction system 102. It should be noted that the tabular data processing pipeline 110 may employ one of the LLM 130a and the LLM 130b for extracting data triples from text data, classifying data triples to classified triples, or the like, according to various implementations of the present disclosure.

In the example of FIG. 1, the tabular data processing pipeline 110 may receive tabular data from the tabular data source 120, where the tabular data may include at least a first table that has a first plurality of columns and a second table that has a second plurality of columns. The tabular data processing pipeline 110 may then generate a first prompt for the LLM 130a and/or the LLM 130b, where the first prompt may include at least a portion (e.g., name of the first table, names of the first plurality of columns, or other information contained in the first table) of the first table and at least a portion (e.g., name of the second table, names of the second plurality of columns, or other information contained in the second table) of the second table. The tabular data processing pipeline 110 may transmit the first prompt to the LLM 130a and/or 130b and receive a first output from the LLM 130a and/or 130b in response to the first prompt, where the first output may include at least a first connection between a first column of the first plurality of columns and a first column of the second plurality of columns.

The first connection may be identified by the LLM 130a and/or 130b and may indicate the first column of the first plurality of columns and the first column of the second plurality of columns are related to (e.g., having similar column names, having similar contents in entries, or having other similar information) each other. The data extraction system 102 may further provide, via the user interface module 104, an interactive graphical representation including at least a first node representing a name of the first column of the first plurality of columns, a second node representing a name of the first column of the second plurality of columns, and a first edge connecting the first node and the second node, the first edge representing the first connection that is included in the first output from the LLM 130a and/or 130b. Based at least in part on receiving a user operation made via the interactive graphical representation to at least the first node, the data extraction system 102 may create and/or update the ontology 105 to include a first data object type corresponding to the name of the first column of the first plurality of columns.

As such, the data extraction system 102 can streamline the process of creating and/or updating the ontology 105 based on tabular data through automated techniques that utilize LLMs and interactive graphical representation for creating and/or updating the ontology 105 from portions of tabular data that users are interested in. Further, by employing one or more LLMs for processing tabular information, the data extraction system 102 may more efficiently identify relationships between columns across disparate data tables for creating a customized ontology based on portions of tables that are related to each other. Additionally, the data extraction system 102 can define the ontology 105 the user 150 intends to create or update using one or more transformations that transform columns of tables selected by users for creating the ontology 105 and adding data objects to the database 109 based on the ontology 105, where the one or more transformations can be stored in database(s) of the system as code that specifies the one or more transformations. As such, the user 150 can flexibly and quickly create or update the ontology 105 and/or add data objects to the database 109 at various desired timing, for example, by executing the code that specifies the one or more transformations generated based on user operations to the interactive graphical representation.

### Example System and Related Modules

In various implementations, techniques described herein, including with relation to data objects, triples and/or tabular data, the ontology, and/or the like, can be applied only to public documents or data to ensure that no private information is inappropriately added to the ontology. This may involve, for example, an initial check or filter of the documents or data being processed to ensure that they are not private documents or data. Additionally, in various implementations, the entities extracted or identified can be checked against a list of restricted entity types (e.g., a list of private or personal entity types such as health information or detailed banking information). Thus, for example, if the extracted or identified entities match against a restricted entity type, the method or system can responsively omit adding the extracted or identified entities to the ontology to facilitate the protection of private information. Accordingly, in various implementations, the system can include various privacy preserving functionality, such as filtering, anonymizing, obfuscation, aggregating, and/or the like, in combination with various other aspects and functionality of the system.

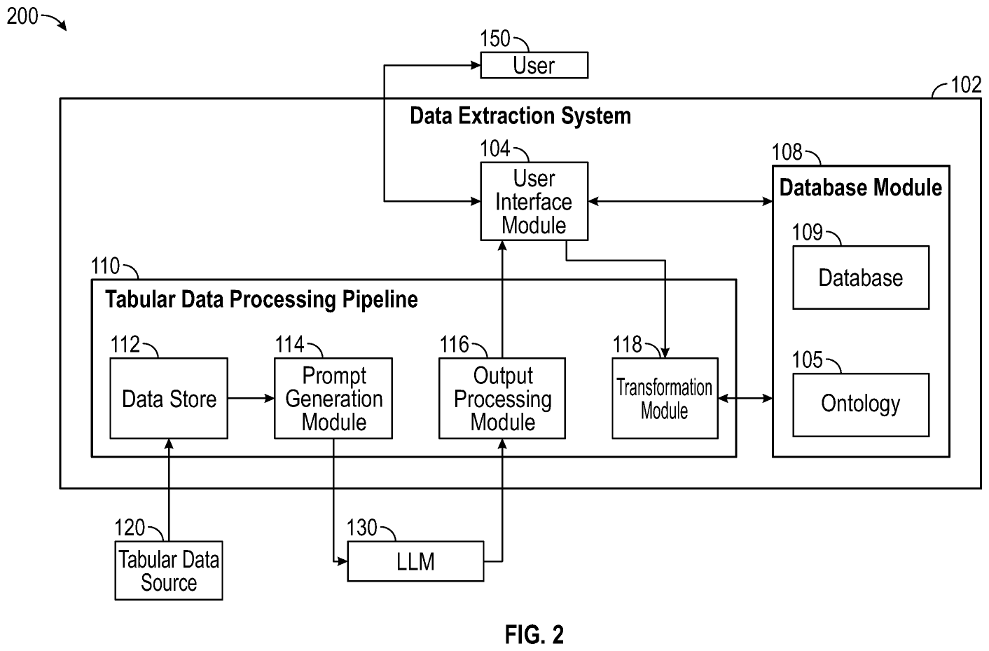

FIG. 2 depicts example connections between various modules of the data extraction system 102 of FIG. 1, including the user interface module 104, the database module 108 that includes the ontology 105 and the database 109, and the tabular data processing pipeline 110 that includes a data store 112, a prompt generation module 114, a output processing module 116, and a transformation module 118. In other implementations, the data extraction system 102 may include fewer or additional connections. The indicated connections and/or data flows of FIG. 2 are exemplary of only certain processes performed by the data extraction system 102 and is not meant to include all possible blocks and participants. In various implementations, at least some of the modules (e.g., the data store 112, the prompt generation module 114, and the output processing module 116) in the data extraction system 102 can be combined or integrated and/or at least some of the modules (e.g., the data store 112) can be omitted. Although one LLM (a LLM 130) is illustrated in FIG. 2, it should be noted that the data extraction system 102 can employ more than one LLM to perform data analysis (e.g., identify relationship(s) between columns of tables in tabular data) described herein.

As described above, the user interface module 104 is configured to generate user interface data that may be rendered on the user 150 (which generally refers to a computing device of any type and/or a human user of the device), such as to receive an initial user operation, as well as later user operation that may be used to initiate further data processing. The functionality discussed with reference to the user interface module 104, and/or any other user interface functionality discussed herein, may be performed by a device or service outside of the data extraction system 102 and/or the user interface module 104 may be outside the data extraction system 102. A user 150 may provide a user operation to the user interface module 104 indicating one or more columns of tables in tabular data from the tabular data source 120 are to be defined into the ontology 105 and/or data analysis to be performed by the data extraction system 102. Alternatively and/or optionally, data analysis (e.g., receiving tabular data from the tabular data source 120) performed by the data extraction system 102 may not need to be initiated by user operations from the user 150.

In various implementations, the data store 112 may receive tabular data from the tabular data source 120, where the tabular data may include at least a first table that has a first plurality of columns and a second table that has a second plurality of columns.

The prompt generation module 114 may then generate a first prompt for the LLM 130, where the first prompt may include at least a portion (e.g., name of the first table, names of the first plurality of columns, or other information contained in the first table) of the first table and at least a portion (e.g., name of the second table, names of the second plurality of columns, or other information contained in the second table) of the second table. The prompt generation module 114 may transmit the first prompt to the LLM.

The output processing module 116 may receive a first output from the LLM 130 in response to the first prompt, where the first output may include at least a first connection between a first column of the first plurality of columns and a first column of the second plurality of columns. The first connection may be identified by the LLM 130 and may indicate the first column of the first plurality of columns and the first column of the second plurality of columns are related to (e.g., having similar column names, having similar contents in entries, or having other similar information) each other.

To identify the first connection that may indicate certain relationships between the first column of the first plurality of columns and the first column of the second plurality of columns, the LLM 130 and/or the data extraction system 102 may utilize various data processing techniques such as vectorization and similarity search. For example, the LLM 130 and/or the tabular data processing pipeline 110 may vectorize the first column of the first plurality of columns into a first vector, and vectorize the first column of the second plurality of columns into a second vector. The LLM 130 and/or the tabular data processing pipeline 110 may then execute, using at least the first vector and the second vector, a similarity search to establish the first connection between the first column of the first plurality of columns and the first column of the second plurality of columns are related to each other. The LLM 130 and/or the tabular data processing pipeline 110 may execute the similarity search using one of the cosine similarity search, approximate nearing neighbor (ANN) algorithms, k nearest neighbors (KNN) method, locality sensitive hashing (LSH), range queries, or any other vector clustering and/or similarity search algorithms. For example, the LLM 130 and/or the tabular data processing pipeline 110 may vectorize names of the first column of the first plurality of columns and first column of the second plurality of columns and/or vectorize contents in the entries of the first column of the first plurality of columns and first column of the second plurality of columns. The LLM 130 and/or the tabular data processing pipeline 110 may then execute the similarity search to identify if the names and/or contents of the first column of the first plurality of columns and first column of the second plurality of columns are similar or related.

The relationship between the first column of the first plurality of columns and first column of the second plurality of columns along with other relationships between columns of the same table may then be presented by the data store 112 through the user interface module 104. Advantageously, the relationships identified by the LLM 130 and/or the tabular data processing pipeline 110 as well as relationships between columns of a table that may be included in the table may allow the user 150 to efficiently observe connections among data from disparate sources for creating the ontology 105 based on the need of the user 150.

The user interface module 104 can provide an interactive graphical representation of columns of tables and relationships among columns of tables. For example, the interactive graphical representation may include a graph-based visualization that include a plurality of nodes and a plurality of edges, where the nodes may represent names of columns of tables and/or the edges may represent relationships between columns of tables. By performing various operations (e.g., select, drag, move, group, or the like) on the nodes or edges of the graph-based visualization, the user 150 may more efficiently create the ontology 105 to define object types, properties, or link types based on names of columns or relationships between columns for enriching knowledge base of an organization in line with objective of the organization. Based on object types defined in the ontology 105, the tabular data processing pipeline 110 (e.g., the transformation module 118) may further automatically generate data objects using contents within columns of tables.

In various implementations, the user interface module 104 may provide, via a user interface, an interactive graphical representation including at least a first node representing a name of a first column of a first plurality of columns of a first table, a second node representing a name of a first column of a second plurality of columns of a second table, and a first edge connecting the first node and the second node, the first edge representing a first connection between the first column of the first plurality of columns of the first table and the first column of the second plurality of columns of the second table. Based at least in part on receiving a first user operation made via the interactive graphical representation to at least the first node, the data extraction system 102 may create and/or update the ontology 105 to include a first data object type corresponding to the name of the first column of the first plurality of columns.

For example, the first user operation may indicate that the name of the first column of the first plurality of columns represented by the first node is to be defined in the ontology as the first data object type. In response to receiving the first user operation, the data extraction system 102 may update the ontology 105 to define the first data object type in the ontology 105. Based at least in part on updating the ontology 105 to include the first data object type, the data extraction system 102 may further optionally add (e.g., through one or more transformations that may be performed by the transformation module 118) into the database 109 a plurality of first data objects of the first data object type, where the plurality of first data objects may represent entries of the first column of the first plurality of columns.

In addition to visualizing the first node and the second node, the user interface module 104 may further provide a third node via the interactive graphical representation to represent a name of a second column of the first plurality of columns. In response to receiving a second user operation, made via the interactive graphical representation, that associates the third node with the second node, the data extraction system 102 may update the ontology 105 to include a second data object type corresponding to the name (e.g., client) of the first column of the second plurality of columns, and a first property type of the second data object type based on the name (e.g., birthday) of the second column of the first plurality of columns represented by the third node. As such, the data extraction system 102 may provide the user 150 the flexibility to create and/or update the ontology 105 by adding a data object type using one column of a table and adding a property type of the data object type using another column of the table or another table.

Additionally, the data extraction system 102 may further provide users the flexibility to update the ontology 105 by changing a property type of a data object type to another data object type, thereby allowing users to efficiently switching between data object types and property types using columns of tables. For example, the user interface module 104 may further receive a third user operation, via the interactive graphical representation, that disassociates the third node with the second node. Based at least in part on receiving the third user operation, the data extraction system 102 may update the ontology 105 to include the second data object type corresponding to the name of the first column of the second plurality of columns without the first property type of the second data object type, and to also include a third data object type corresponding to the name of the second column of the first plurality of columns.

The data extraction system 102 may also provide users the flexibility to create and/or update the ontology 105 to include a data object type corresponding to an entity type that may be defined by the user 150, where the entity type may have property types that are generated based on columns of tables. For example, the user interface module 104 may receive a fourth user operation, via the interactive graphical representation that includes at least the first node, the second node, and the third node, that associates the third node and the second node with a first entity type that is defined by a user, where the fourth user operation indicates that the user 150 intends to create a data object type that has property types based on the names of the first column of the second plurality of columns and the second column of the first plurality of columns. Based at least in part on receiving the fourth user operation, the data extraction system 102 may create and/or update the ontology 105 to include at least: (i) a fourth data object type corresponding to the first entity type that is defined by the user, (ii) a first property type of the fourth data object type based on the name of the first column of the second plurality of columns represented by the second node, and (iii) a second property type of the fourth data object type based on the name of the second column of the first plurality of columns represented by the third node. Additionally and/or optionally, based on the created and/or updated ontology 105, the data extraction system 102 may further add into the database 109 a plurality of fourth data objects of the fourth data object type. Specifically, one of the plurality of fourth data objects may have a first property of the first property type representing an entry of the first column of the second plurality of columns, and a second property of the second property type representing an entry of the second column of the first plurality of columns. In various implementations, the data extraction system 102 (e.g., the transformation module 118) may generate the plurality of fourth data objects of the fourth data object type based on one or more rules defined by the user 150, where the one or more rules may instruct the data extraction system 102 how and/or which entries of columns are utilized to generate data objects. As such, the user 150 may efficiently customize the ontology 105 and convert tabular data to data objects of data object types defined by the ontology 105.

In creating and/or updating the ontology 105 through graph-based visualization, the user interface module 104 may further visualize an existing ontology 105 using an interactive graphical representation of the user interface. For example, the user interface module 104 may provide a fourth node, via the interactive graphical representation, that represents an entity type corresponding to a data object type that has been defined in the ontology 105. Advantageously, the user 150 may better understand what already exists in the ontology 105 through visualization.

In various implementations, the user interface module 104 may further provide an interactive graphical representation to visualize relationship(s) between columns of a table, where information regarding the relationship(s) may be contained in the table. For example, the interactive graphical representation may include a fifth node, a sixth node, and a second edge connecting the fifth node and the sixth node, where the fifth node represents a name of a third column of the first plurality of columns of the first table, the sixth node represents a name of a fourth column of the first plurality of columns of the first table, the second edge represents a second connection between the third column of the first plurality of columns of the first table and the fourth column of the first plurality of columns of the first table, and information contained in the first table is indicative of the second connection. Advantageously, the user 150 may better understand relationships between columns of the same table and may utilize relationships between columns of the same table and/or different tables to create and/or update the ontology 105 that is consistent with the needs of an organization.

In various implementations, the data extraction system 102 may receive tabular data that includes at least a plurality of tables, and may provide an interactive graphical representation that includes at least a plurality sets of nodes, where each of the plurality sets of nodes corresponds to each of the plurality of tables. The interactive graphical representation may present nodes in manners that the user 150 can more easily observe. For example, the interactive graphical representation may represent nodes of each respective set of nodes to be visually similar (e.g., coated with the same color), and represent nodes of different sets of nodes to be visually distinctive (e.g., coated with different colors)

Once the user 150 performs operations on the nodes or edges of the graph-based visualization, the transformation module 118 can define the ontology 105 the user intends to create or update using one or more transformations that transform columns of tables selected by users for creating the ontology 105, where the one or more transformations can be stored in database(s) of the system as code that specifies the one or more transformations. When the user triggers the one or more transformations (e.g., through the graphical interactive representation), the transformation module 118 may execute the code to transform columns of tables selected by the user to the ontology 105 the user intends to create or update and generate data objects of data object types defined in the ontology 105 based on one or more rules defined by the user 150.

More specifically, in response to one or more user operations (e.g., select, drag, move, group, or the like) on nodes or edges that represent names of columns of tables or relationships between columns of tables, the transformation module 118 may generate code to specify a transformation for defining the ontology 105 that the one or more user operations intend to create using names and/or relationships of the columns of tables. The transformation module 118 may further execute the code to apply the ontology to tabular data to generate one or more data objects and/or links between the one or more data objects and store the one or more data objects and/or links into the database 109. Advantageously, the transformation specified by the code enables the user 150 to efficiently convert, at various desired timing, tabular data to data objects of data object types defined in the ontology 105, where the ontology 105 may be created and/or updated based on user operations on interactive graphical representations.

### Example Database and Data Models

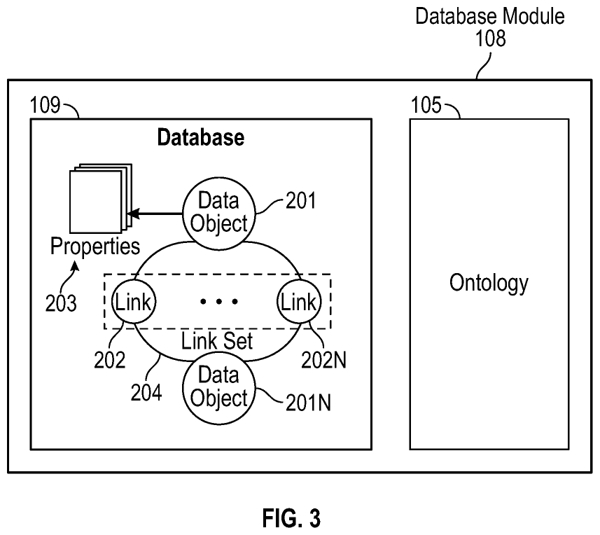

FIG. 3 illustrates an object-centric conceptual data model in the database module 108 of the data extraction system 102 according to various implementations of the present disclosure. The database module 108 may store the ontology 105 and the database 109. The ontology 105, as noted above, may include stored information providing a data model for storage of data in the database 109. The ontology 105 may be defined by one or more data object types, which may each be associated with one or more property types. At the highest level of abstraction, data object 201 is a container for information representing things in the world. For example, the data object 201 can represent an entity such as a particular person, place, organization, date, market instrument, item, or other noun, where the entity may appear in text data such as a document, an e-mail message, a news report, a written paper, an article, or the like. Data object 201 can also represent an event that happens at a point in time or for a duration. Each data object 201 may be associated with a unique identifier that uniquely identifies the data object within the database 109 of the database module 108.

In various implementations, different types of data objects may have different property types. For example, a “Person” data object might have an “Eye Color” property type and an “Event” data object might have a “Date” property type. Each property 203 as represented by data in the database module 108 may have a property type defined by the ontology 105 used by the database module 108. Objects may be instantiated in the database 109 in accordance with the corresponding object definition for the particular object in the ontology 105. For example, a specific monetary payment (e.g., an object of type “event”) of US$30.00 (e.g., a property of type “currency”) taking place on Mar. 27, 2009 (e.g., a property of type “date”) may be stored in the database 109 as an event object with associated currency and date properties as defined within the ontology 105. The data objects defined in the ontology 105 may support property multiplicity. In particular, the data object 201 may be allowed to have more than one property 203 of the same property type. For example, a “Person” data object might have multiple “Address” properties or multiple “Name” properties. Each link 202 represents a connection between two data objects 201. In one implementation, the connection is either through a relationship, an event, or through matching properties. A relationship connection may be asymmetrical or symmetrical. For example, “Person” data object A may be connected to “Person” data object B by a “Child Of” relationship (where “Person” data object B has an asymmetric “Parent Of” relationship to “Person” data object A), a “Kin Of” symmetric relationship to “Person” data object C, and an asymmetric “Member Of” relationship to “Organization” data object X. The type of relationship between two data objects may vary depending on the types of the data objects. For example, “Person” data object A may have an “Appears In” relationship with “Document” data object Y or have a “Participate In” relationship with “Event” data object E. As an example of an event connection, two “Person” data objects may be connected by an “Airline Flight” data object representing a particular airline flight if they traveled together on that flight, or by a “Meeting” data object representing a particular meeting if they both attended that meeting. In one implementation, when two data objects are connected by an event, they are also connected by relationships, in which each data object has a specific relationship to the event, such as, for example, an “Appears In” relationship.

As an example of a matching properties connection, two “Person” data objects representing a brother and a sister, may both have an “Address” property that indicates where they live. If the brother and the sister live in the same home, then their “Address” properties likely contain similar, if not identical property values. In one implementation, a link between two data objects may be established based on similar or matching properties (e.g., property types and/or property values) of the data objects. These are just various examples of the types of connections that may be represented by a link and other types of connections may be represented; implementations are not limited to any particular types of connections between data objects. For example, a document might contain references to two different objects. For example, a document may contain a reference to a payment (one object), and a person (a second object). A link between these two objects may represent a connection between these two entities through their co-occurrence within the same document. Each data object 201 can have multiple links with another data object 201 to form a link set 204. For example, two “Person” data objects representing a husband and a wife could be linked through a “Spouse Of” relationship, a matching “Address” property, and one or more matching “Event” properties (e.g., a wedding). Each link 202 as represented by data in the database 109 may have a link type defined by the ontology 105 and/or used by the database 109.

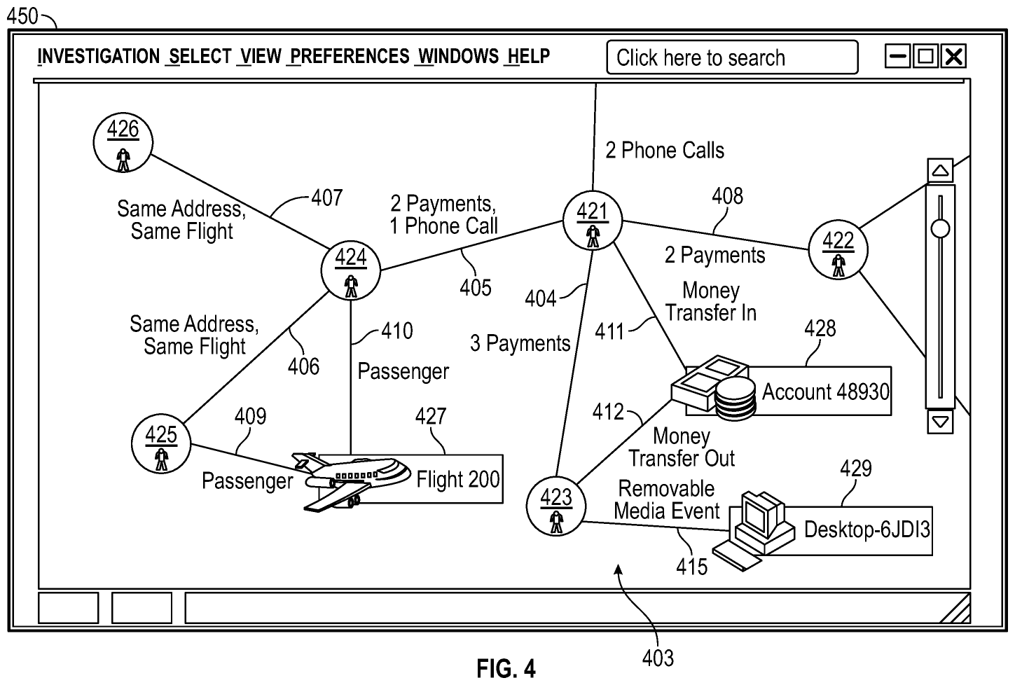

For case of understanding, data objects (e.g., the data object 201 and the data object 201N), links between data objects (e.g., the link 202 and link 202N) that may represent relationships between the data objects, and properties of data objects (e.g., the properties 203) can be visualized using one or more graphical user interfaces (GUI). For example, FIG. 4 displays an example user interface 400 showing a graphical representation 403 of relationships (including relationships and/or links 404, 405, 406, 407, 408, 409, 410, 411, 412, and 413) between the data objects (including data objects 421, 422, 423, 424, 425, 426, 427, 428, and 429) that are represented as nodes in the example of FIG. 4. In this implementation, the data objects include person data objects 421, 422, 423, 424, 425, and 426; a flight data object 427; an account 428; and a computer data object 429. In this example, each person node (associated with person data objects), flight node (associated with flight data objects), account node (associated with account data objects), and computer node (associated with computer data objects) may have relationships and/or links with any of the other nodes through, for example, other objects such as payment data objects. For example, in FIG. 4, relationship 404 is based on a payment associated with the individuals indicated in person data objects 421 and 423. The link 404 represents these shared payments (for example, the individual associated with data object 421 may have paid the individual associated with data object 423 on three occasions). The relationship is further indicated by the common relationship between person data objects 421 and 423 and account data object 428. For example, link 411 indicates that person data object 421 transferred money into account data object 428, while person data object 423 transferred money out of account data object 428. In another example, the relationships between person data objects 424 and 425 and flight data object 427 are indicated by links 406, 409, and 410. In this example, person data objects 424 and 425 have a common address and were passengers on the same flight data object 427. In an implementation, further details related to the relationships between the various objects may be displayed. For example, links 411 and 412 may, in some implementations, indicate the timing of the respective money transfers. In another example, the time of the flight associated with the flight data object 427 may be shown.

Relationships between data objects may be stored as links, or in some implementations, as properties, where a relationship may be detected between the properties. In some cases, as stated above, the links may be directional. For example, a payment link may have a direction associated with the payment, where one person object is a receiver of a payment, and another person object is the payer of payment.

In addition to visually showing relationships between the data objects, the user interface may allow various other manipulations. For example, the objects within database module 108 may be searched using a search interface 450 (e.g., text string matching of object properties), inspected (e.g., properties and associated data viewed), filtered (e.g., narrowing the universe of objects into sets and subsets by properties or relationships), and statistically aggregated (e.g., numerically summarized based on summarization criteria), among other operations and visualizations.

### Example Functionality and Operations of the System

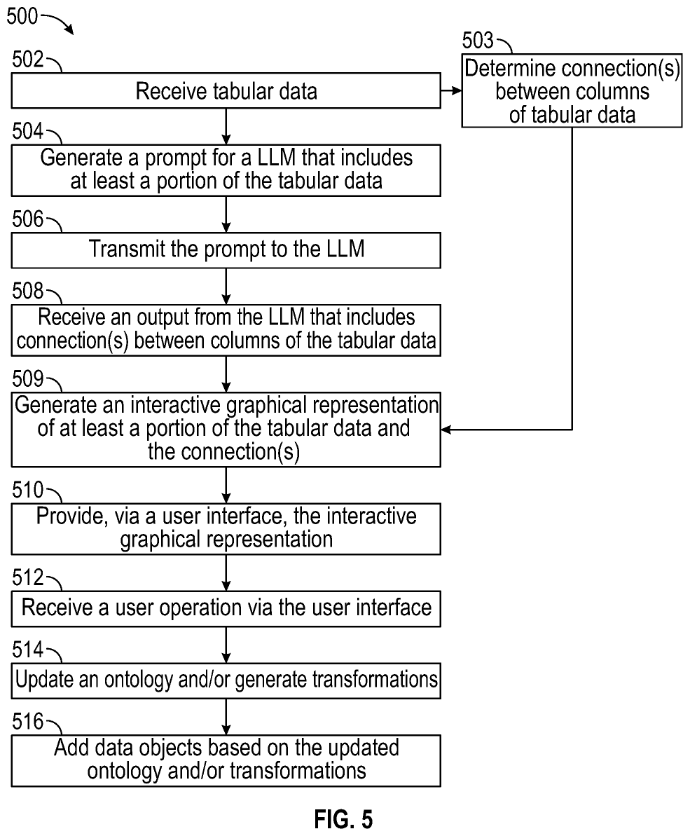

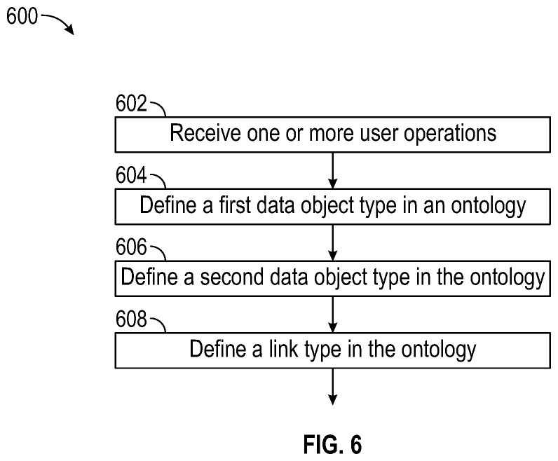

FIGS. 5 and 6 show flowcharts illustrating example operations of the data extraction system 102 (and/or various other aspects of the example computing environment 100), according to various implementations. The blocks of the flowcharts illustrate example implementations, and in various other implementations various blocks may be rearranged, optional, and/or omitted, and/or additional block may be added. In various implementations, the example operations of the data extraction system 102 illustrated in FIGS. 5 and 6 may be implemented, for example, by the one or more aspects of the data extraction system 102 (e.g., the tabular data processing pipeline 110 and the user interface module 104), various other aspects of the example computing environment 100, and/or the like.

FIG. 5 depicts a flowchart illustrating an example method 500 according to various implementations. The method 500 may be implemented, for example, by the data extraction system 102 of FIGS. 1 and 2 to for creating and/or updating the ontology 105 based on tabular data and user operations from the user 150.

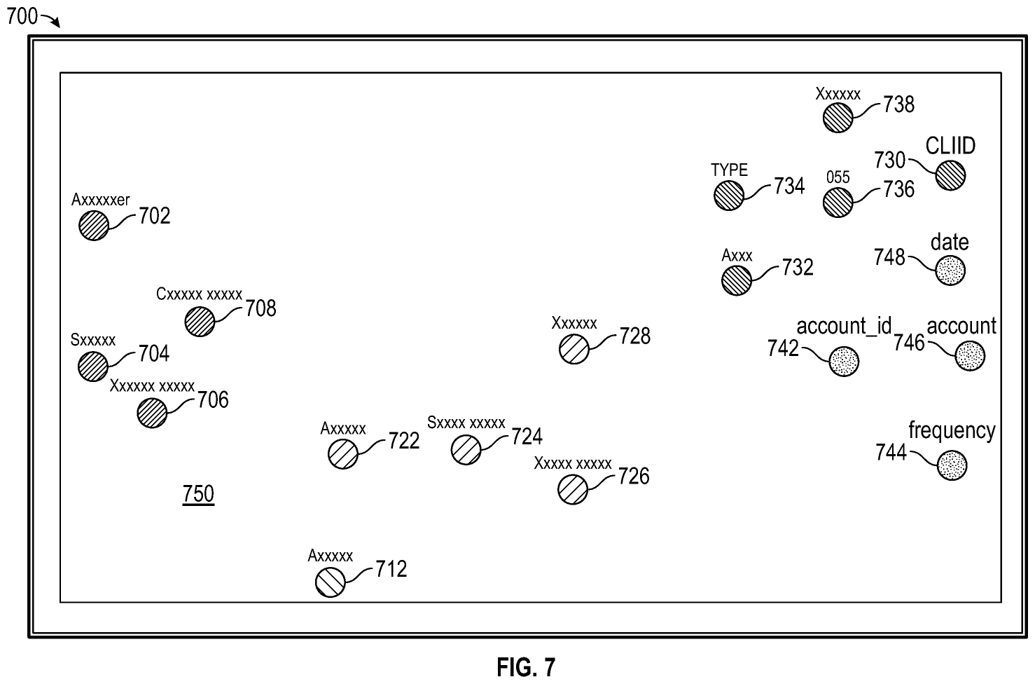

At block 502, the data extraction system 102 may receive tabular data. For example, the tabular data processing pipeline 110 may receive tabular data from the tabular data source 120. The tabular data may include, for example, at least a first table that has a first plurality of columns and a second table that has a second plurality of columns. As an example for illustrative purposes, the tabular data received by the data extraction system 102 may include five tables as illustrated in FIG. 7, where each of the nodes 702, 704, 706, and 708 may represent a name of a column in a first table, each of the nodes 722, 724, 726, and 728 may represent a name of a column in a second table, each of the nodes 730, 732, 734, 736, and 738 may represent a name of a column in a third table, each of the nodes 742, 744, 746, and 748 may represent a name of a column in a fourth table, and the node 712 may represent a name of a column in a fifth table. In this example, the first table has four columns, the second table has four columns, the third table has five columns, the fourth table has four columns, and the fifth table has one column. It should be noted that other number of tables and/or columns in a table may be included in the tabular data received by the data extraction system 102.

The method 500 may proceed to block 503 or blocks 504, 506, and 508 for identifying relationships among columns of tables in the tabular data. For example, the method may proceed to block 504, where the data extraction system 102 (e.g., the prompt generation module 114) generates a prompt for the LLM 130 that includes at least a portion of the tabular data. As an example for illustrative purposes, the prompt for the LLM 130 may include names of columns that are represented by the nodes 702, 704, 706, 708, 712, 722, 724, 726, 728, 732, 734, 736, 738, 730, 742, 748, 746, and 744 as illustrated in FIG. 7 but may not include every entry in the columns corresponding to the nodes 702, 704, 706, 708, 712, 722, 724, 726, 728, 732, 734, 736, 738, 730, 742, 748, 746, and 744. The prompt may further include instructions to the LLM to perform a particular task, e.g., to generate identify relationships among the columns of the tabular data, optionally according to example(s) provided.

At block 506, the data extraction system 102 may transmit the prompt to a LLM. For example, the prompt generation module 114 may transmit the prompt to the LLM 130. The prompt may include at least a portion of the first table and at least a portion of the second table that are included in the tabular data received from the tabular data source 120.

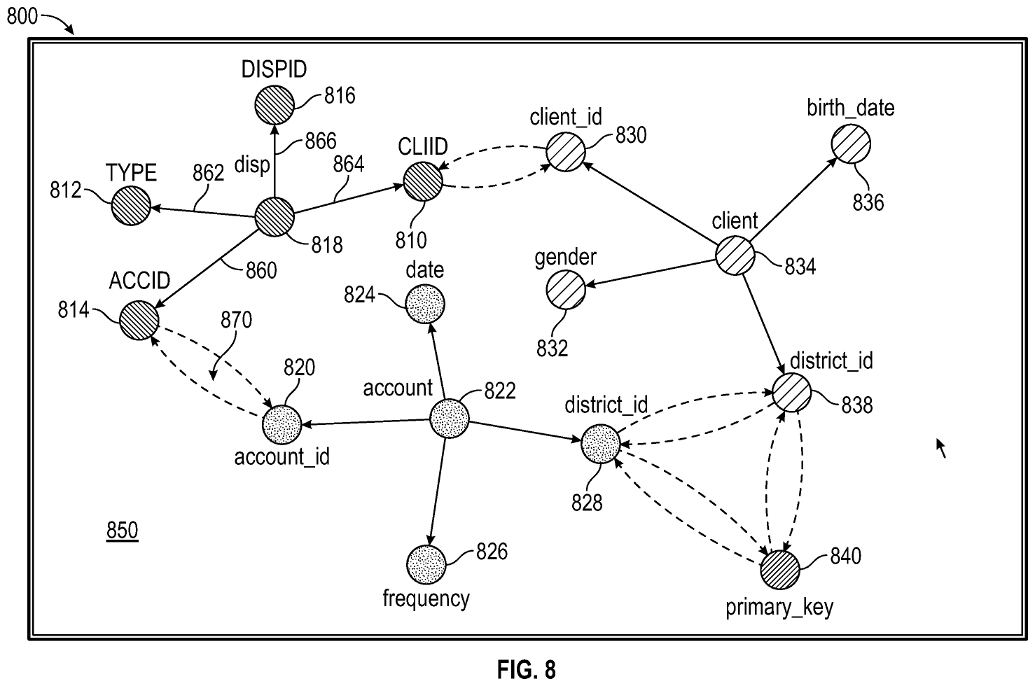

At block 508, the data extraction system 102 (e.g., the output processing module 116) may receive an output from the LLM 130 that includes connection(s) between columns of the tabular data. For example, the output processing module 116 may receive the output from the LLM 130 that includes at least a first connection between a first column of the first plurality of columns and a first column of the second plurality of columns. For example, the output from the LLM 130 may be illustrated by FIG. 8, where edges 870, 862, 866, 864, and 860 may be connections between columns of the tabular data identified by the LLM 130. More specifically, the edge 870 represents a connection between the node 814 that represents a name of a column in a first table and the node 820 that represents a name of a column in a second table. The edges 860, 862, 864, and 866 represent connections between columns of the first table.

As noted above, the method 500 can proceed to block 503 from block 502 for identifying relationships among columns of tables in the tabular data. At block 503, rather than employing the LLM 130 to identify relationships among columns of tables in the tabular data, the tabular data processing pipeline 110 may identifying relationships among columns of tables in the tabular data by utilizing various data processing techniques such as vectorization and similarity search (that may also be utilized by the LLM 130 in the instance that the method 500 proceeds to blocks 504, 506, and 508 from block 502). For example, the tabular data processing pipeline 110 may vectorize the first column of the first plurality of columns into a first vector, and vectorize the first column of the second plurality of columns into a second vector. The tabular data processing pipeline 110 may then execute, using at least the first vector and the second vector, a similarity search to establish the first connection between the first column of the first plurality of columns and the first column of the second plurality of columns are related to each other. The tabular data processing pipeline 110 may execute the similarity search using one of the cosine similarity search, approximate nearing neighbor (ANN) algorithms, k nearest neighbors (KNN) method, locality sensitive hashing (LSH), range queries, or any other vector clustering and/or similarity search algorithms. More specifically, the tabular data processing pipeline 110 may vectorize names of the first column of the first plurality of columns and first column of the second plurality of columns and/or vectorize contents in the entries of the first column of the first plurality of columns and first column of the second plurality of columns. The tabular data processing pipeline 110 may then execute the similarity search to identify if the names and/or contents of the first column of the first plurality of columns and first column of the second plurality of columns are similar or related.

Alternatively and/or optionally, the tabular data processing pipeline 110 and the LLM 130 may each perform a part of the vectorization and similarity search for identifying relationships among columns of tables in the tabular data.

At block 509, the data extraction system 102 may generate an interactive graphical representation of at least a portion of the tabular data and the connection(s) among the portion of the tabular data. For example, the interactive graphical representation may include at least a first node representing a name of the first column of the first plurality of columns, a second node representing a name of the first column of the second plurality of columns, and a first edge connecting the first node and the second node, where the first edge represents the first connection that may be identified at block 508 and/or 503.

At block 510, the data extraction system 102 may provide the interactive graphical representation via the user interface module 104. For example, the interactive graphical representation may include a graph-based visualization that includes at least the first node representing a name of the first column of the first plurality of columns and the second node representing a name of the first column of the second plurality of columns. An example interactive graphical representation generated by the data extraction system 102 is illustrated by the interactive graphical representation 850 of FIG. 8, where the interactive graphical representation 850 includes nodes 810, 812, 814, 816, 818, 820, 822, 824, 826, 828, 830, 832, 834, 836, 838, and 840, and the edges 870, 860, 862, 864, and 866. Each of the nodes 810, 812, 814, 816, 818. 820, 822, 824, 826, 828, 830, 832, 834, 836, 838, and 840 may represent a name of a column of a table, and each of the edges 870, 860, 862, 864, and 866 may represent a connection between two associated columns.

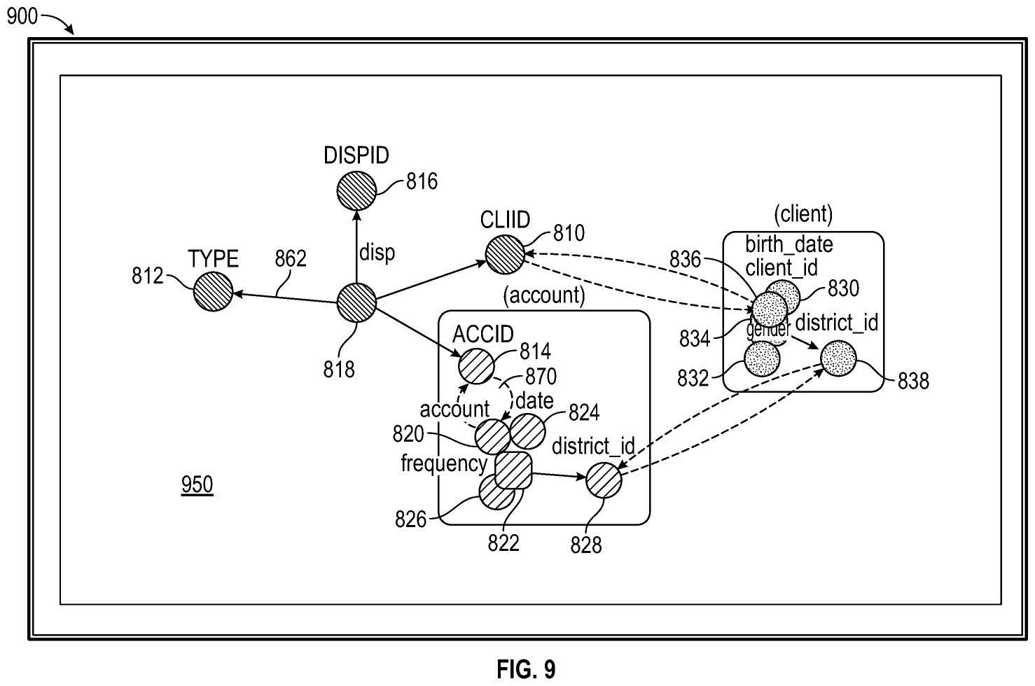

At block 512, the data extraction system 102 may receive user operations via the user interface module 104. For example, the user operations from the user 150 may be directed to various nodes displayed in the user interface. An example operation may indicate, for example, that the name of a first column of a first plurality of columns represented by a first node is to be defined in the ontology 105 as a first data object type. For example, such user operations may be illustrated by the example user interface 900 of FIG. 9. More specifically, the user interface module 104 may receive the first user operation on the nodes 814, 820, 824, 826, 822, and 828 as illustrated in FIG. 9, where the first user operation may indicate to the data extraction system 102 to define a first data object type corresponding to the name (“account”) of a column of the second table represented by the node 822. Additionally, the first user operation may indicate to the data extraction system 102 that the first data object type should include a first property type based on a name of a column of the first table represented by the node 814, a second property type based on a name of a column of the second table represented by the node 820, a third property type based on a name of a column of the second table represented by the node 824, a fourth property type based on a name of a column of the second table represented by the node 826, and a fifth property type based on a name of a column of the second table represented by the node 828. As another example, as illustrated in FIG. 9, the first user operation may indicate to the data extraction system 102 to define a second data object corresponding to the name (“client”) of a column of the third table represented by the node 834. The first user operation may indicate to the data extraction system 102 that the second data object type should include a first property type based on a name of a column of the third table represented by the node 830, a second property type based on a name of a column of the third table represented by the node 832, a third property type based on a name of a column of the third table represented by the node 836, and a fourth property type based on a name of a column of the third table represented by the node 838. Other types of user operations may be provided, which, for example, may group and/or ungroup various nodes to define various data object types and/or properties associated with the data object types.

At block 514, in response to receiving the user operations, the data extraction system 102 may update the ontology 105 and/or generate transformations that define the ontology 105. For example, the data extraction system 102 may update the ontology 105 to define a first data object type in the ontology 105. For example, as illustrated in FIG. 9, the data extraction system 102 may update the ontology 105 to define a first data object type corresponding to the name (“account”) of a column of the second table represented by the node 822 and/or update the ontology 105 to define a second data object corresponding to the name (“client”) of a column of the third table represented by the node 834.

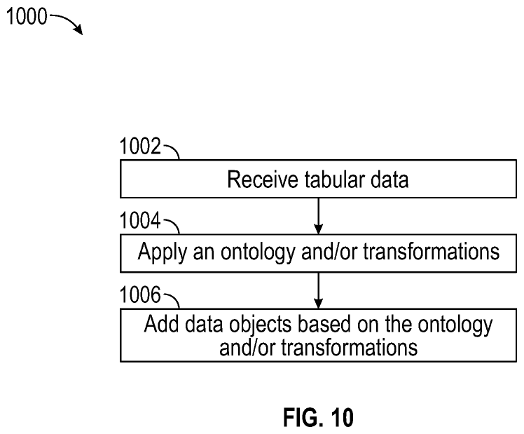

At block 516, the data extraction system 102 may add objects based on the updated ontology 105 and/or transformations. For example, by executing a code that stores the transformation defining the ontology 105, the data extraction system 102 may add into the database 109 a plurality of first data objects of the first data object type, where the plurality of first data objects represents entries of the first column of the first plurality of columns. For example, the data extraction system 102 may add data objects to the database 109 by implementing the example method 1000 of FIG. 10 that will be described with greater detail.

Optionally, the interactive graphical representation provided at block 510 may further include a third node that represents a name of a second column of the first plurality of columns, and the data extraction system 102 (e.g., the user interface module 104) may further receive a second user operation that associates the third node and the second node with a first entity type, where the first entity type may be defined by the user 150. Based at least in part on receiving the second user operation, the data extraction system 102 may update the ontology 105 to include: (a) a fourth data object type corresponding to the first entity type, (b) a first property type of the fourth data object type based on the name of the first column of the second plurality of columns represented by the second node, and (c) a second property type of the fourth data object type based on the name of the second column of the first plurality of columns represented by the third node. Based on the updated ontology 105, the data extraction system 102 may add into the database 109 a plurality of fourth data objects of the fourth data object type, where one of the plurality of fourth data objects has a first property of the first property type representing an entry of the first column of the second plurality of columns, and a second property of the second property type representing an entry of the second column of the first plurality of columns.

FIG. 6 is a flowchart illustrating an example method 600 for defining an ontology (e.g., the ontology 105) based on user operations. In various implementations, the method 600 may be performed in part or in full by the data extraction system 102. In various implementations, the method 600 may be performed by the data extraction system 102 after the interactive graphical representation is provided at block 510 of FIG. 5.

At block 602, the data extraction system 102 may receive one or more user operations. For example, the user interface module 104 may receive the one or more user operations to an interactive graphical representation that includes at least a first node representing a name of a first column of a first plurality of columns, a second node representing a name of a first column of a second plurality of columns, and a first edge connecting the first node and the second node, the first edge representing a first connection between the first column of the first plurality of columns and the first column of the second plurality of columns. The one or more user operations may indicate that a name of the first column of the first plurality of columns represented by the first node is to be defined in the ontology 105 as a first data object type, a name of the first column of the second plurality of columns represented by the second node is to be defined in the ontology 105 as a second data object type, and the first connection between the first column of the first plurality of columns and the first column of the second plurality of columns represented by the first edge is to be defined in the ontology 105 as a link type between the first data object type and the second data object type. As noted above, the one or more user operations may be illustrated by the user operation(s) on the interactive graphical representation 950 as illustrated in FIG. 9.

At block 604, the data extraction system 102 may define the first data object type in the ontology 105. At block 606, the data extraction system 102 may define the second data object type in the ontology 105. At block 608, the data extraction system 102 may define the link type in the ontology 105. For example, as illustrated in FIG. 9, the data extraction system 102 may update the ontology 105 to define a first data object type corresponding to the name (“account”) of a column of the second table represented by the node 822 and/or update the ontology 105 to define a second data object corresponding to the name (“client”) of a column of the third table represented by the node 834. It should be noted that the blocks 604, 606, and 608 do not need to be performed by the data extraction system 102 in sequential order, and may be performed concurrently or in various orders.

### Example User Interfaces and Related Functionality

FIGS. 7-9 show example user interfaces that illustrate example interactive graphical representations of tabular data received from tabular data source 120 to allow the user 150 to more efficiently create and/or update the ontology 105 to define data object types or link types for enriching knowledge base of an organization by performing various user operations on the nodes or edges of the interactive graphical representations. The example user interfaces may be presented through the user interface module 104 of the data extraction system 102 of FIG. 1 and/or FIG. 2 or a user interface of the user 150. The example user interfaces may allow the user 150 to interact with the data extraction system 102 of FIG. 1 and/or FIG. 2 to create and/or update the ontology 105 and/or generate corresponding data objects of data object types defined in the ontology 105.

As shown in FIG. 7, a user interface 700 may include an interactive graphical representation 750 that includes nodes 702, 704, 706, 708, 712, 722, 724, 726, 728, 732, 734, 736, 738, 730, 742, 748, 746, and 744. Each of the nodes 702, 704, 706, 708, 712, 722, 724, 726, 728, 732, 734, 736, 738, 730, 742, 748, 746, and 744 may represent a name of a column of a table. More specifically, each of the nodes 702, 704, 706, and 708 may represent a name of a column in a first table, each of the nodes 722, 724, 726, and 728 may represent a name of a column in a second table, each of the nodes 730, 732, 734, 736, and 738 may represent a name of a column in a third table, each of the nodes 742, 744, 746, and 748 may represent a name of a column in a fourth table, and the node 712 may represent a name of a column in a fifth table. In various implementations, the user interface module 104 may present through the interactive graphical representation 750 the nodes that correspond to the same table to be visually similar (e.g., coated with the same color), and nodes that correspond to different tables to be visually distinctive (e.g., coated with different colors).

FIG. 8 shows a user interface 800 that includes an interactive graphical representation 850 that includes nodes 810, 812, 814, 816, 818, 820, 822, 824, 826, 828, 830, 832, 834, 836, 838, and 840. Each of the nodes 810, 812, 814, 816, 818. 820, 822, 824, 826, 828, 830, 832, 834, 836, 838, and 840 may represent a name of a column of a table. More specifically, each of the nodes 810, 812, 814, 816 and 818 may represent a name of a column in a first table, each of the nodes 820, 822, 824, 826 and 828 may represent a name of a column in a second table, each of the nodes 830, 832, 834, 836 and 838 may represent a name of a column in a third table, and the node 840 may represent a name of a column in a fourth table. In addition to showing the nodes that represent columns of tables, the interactive graphical representation 850 further uses edges to show relationships between columns of the same table or of different tables. For example, the interactive graphical representation 850 includes the edges 860, 862, 864 and 866 to show how columns in the first table are related to each other. For example, the edge 860 shows that the column of the first table represented by the node 814 is connected to the column of the first table represented by the node 818. In various implementations, connections between columns of the same table are represented by edges having solid lines. The interactive graphical representation 850 may further show that columns of different tables are connected with each other using edges having dashed lines. For example, the edge 870 shows that the column of the first table represented by the node 814 and the column of the second table represented by the node 820 are related to each other. As noted above, the connections between columns of the same or different tables may be identified by the data extraction system 102 through, for example, performing the method 500 of FIG. 5.

FIG. 9 shows a user interface 900 illustrating various user operations that may be performed to an interactive graphical representation for creating and/or updating the ontology 105. The user interface 900 includes an interactive graphical representation 950 that may result from one or more user operations performed by the user 150 to the interactive graphical representation 850 of FIG. 8. As shown in FIG. 9, the user interface module 104 may receive a first user operation on the nodes 814, 820, 824, 826, 822, and 828, where the first user operation may indicate to the data extraction system 102 to define a first data object type corresponding to the name (“account”) of a column of the second table represented by the node 822. Additionally, the first user operation may indicate to the data extraction system 102 that the first data object type should include a first property type based on a name of a column of the first table represented by the node 814, a second property type based on a name of a column of the second table represented by the node 820, a third property type based on a name of a column of the second table represented by the node 824, a fourth property type based on a name of a column of the second table represented by the node 826, and a fifth property type based on a name of a column of the second table represented by the node 828.

As shown in FIG. 9, the user interface module 104 may further receive a second user operation on the nodes 830, 832, 834, 836, and 838, where the second user operation may indicate to the data extraction system 102 to define a second data object corresponding to the name (“client”) of a column of the third table represented by the node 834. Additionally, the second user operation may indicate to the data extraction system 102 that the second data object type should include a first property type based on a name of a column of the third table represented by the node 830, a second property type based on a name of a column of the third table represented by the node 832, a third property type based on a name of a column of the third table represented by the node 836, and a fourth property type based on a name of a column of the third table represented by the node 838.

As such, the data extraction system 102 may provide the user 150 the flexibility to create and/or update the ontology 105 based on columns of tables by defining data object types and/or property types using names of columns of tables. It should be noted that other user operations on the interactive graphical representations 850 and 950 can also be facilitated by the data extraction system 102 through the user interface module 104 such that the user 150 can define various data object types having various property types and/or generate various data object of data object types by grouping and/or separating nodes of the interactive graphical representations 850 and 950.

FIG. 10 is a flowchart illustrating an example method 1000 for applying an ontology and/or transformation to tabular data to add data objects to a database, according to various implementations. In various implementations, the method 1000 may be performed in part or in full by the data extraction system 102. In various implementations, the method 1000 may be performed by the data extraction system 102 after the ontology 105 is updated and/or the transformations are generated at block 514 of FIG. 5.

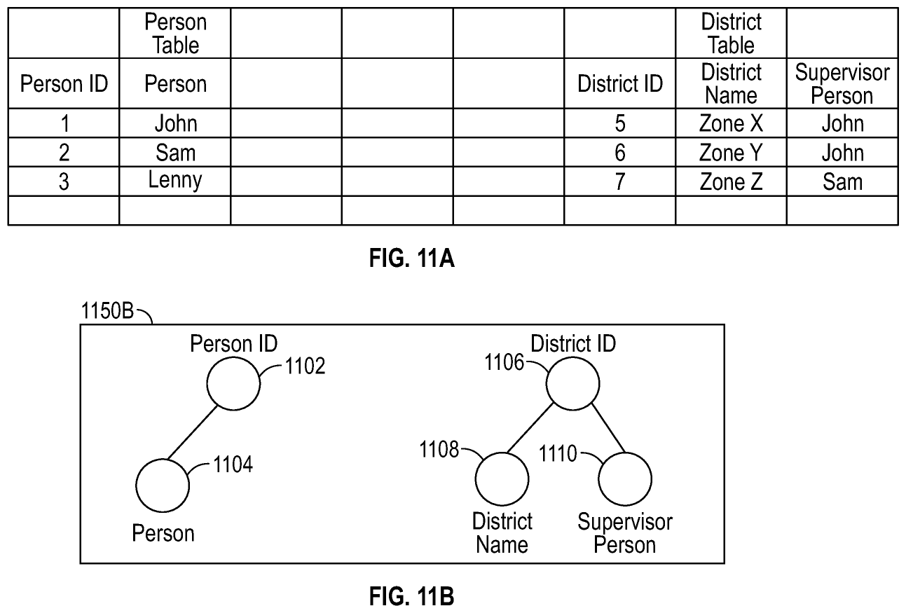

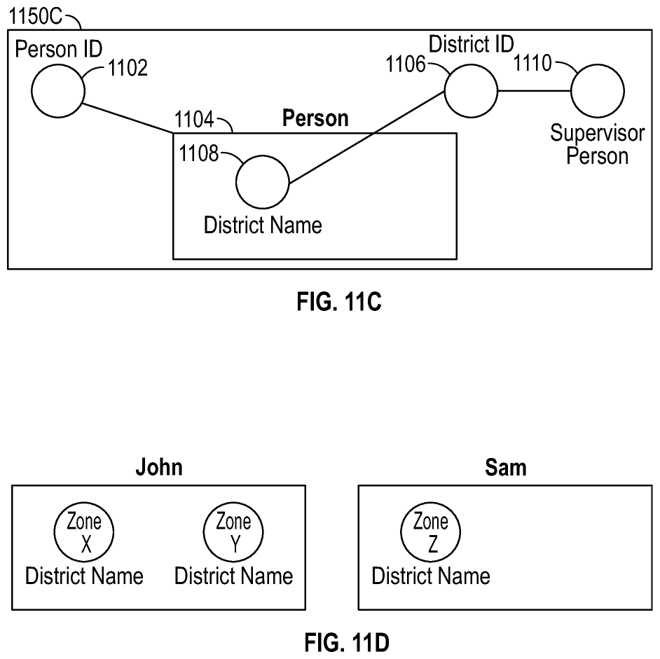

At block 1002, the data extraction system 102 may receive tabular data. For example, the data extraction system 102 may receive tabular data from the tabular data source 120. For example, the tabular data may include two tables (e.g., a Person Table and a District Table) as illustrated in FIG. 11A.

At block 1004, the data extraction system 102 may apply the ontology 105 and/or transformations that define the ontology 105 to the tabular data. As noted above, the transformations that define the ontology 105 may be stored in code and the data extraction system 102 may execute the code to apply the ontology 105 and/or transformations to the tabular data.

At block 1006, the data extraction system 102 may add data objects based on the ontology 105 and/or the transformations that may be stored in the code into the database 109. For example, the data extraction system 102 may add into the database 109 a plurality of first data objects of a first data object type, where the plurality of first data objects represent entries of a first column of a first table in the tabular data. For example, by applying the ontology 105 and/or transformations corresponding to the interactive graphical representation 1150C of FIG. 11C to the tabular data of FIG. 11A, the data extraction system 102 may add to the database 109 two data objects (e.g., a person data object “John” and a person data object “Sam”) as illustrated in FIG. 11D.

FIGS. 11A-11D show an example flow for adding data objects into the database 109 associated with the ontology 105 based on one or more user operations to node(s) of an interactive graphical representation that represent columns of tabular data received from the tabular data source 120, according to various implementations. At least some of the example flow may be performed by the data extraction system 102 of FIG. 1 or FIG. 2 automatically and/or in response to a user operation/input from the user 150.

As shown in FIG. 11A, the data extraction system 102 may receive tabular data from the tabular data source 120. In the example of FIG. 11A, the tabular data includes two tables: a person table that has two columns (e.g., “Person ID” and “Person”) and a district table that has three columns (e.g., “District ID,” “District Name,” and “Supervisor Person”). The data extraction system 102 may identify relationships between the columns in the person table and columns in the district table, for example, by executing blocks 503 and/or blocks 504, 506, and 508 of FIG. 5.

As shown in FIG. 11B, the data extraction system 102 may present the interactive graphical representation 1150B through the user interface module 104 to the user 150, where the interactive graphical representation 1150B includes the nodes 1102, 1104, 1106, 1108, and 1110. As shown in FIGS. 11A and 11B, the node 1102 represents the name (“Person ID”) of the first column of the person table, the node 1104 represents the name (“Person”) of the second column of the person table, the node 1106 represents the name (“District ID”) of the first column of the district table, the node 1108 represents the name (“District Name”) of the second column of the district table, the node 1110 represents the name (“Supervisor Person”) of the third column of the district table. The user 150 may then perform one or more user operations on the interactive graphical representation 1150B to create and/or update the ontology 105.

FIG. 11C illustrates an interactive graphical representation 1150C that may result from the user 150 performing one or more operations (e.g., dragging, selecting, moving the nodes of the interactive graphical representation 1150B) on the interactive graphical representation 1150B of FIG. 11B. As shown in FIG. 11C, the interactive graphical representation 1150C illustrates that the user 150 intends to create and/or update the ontology 105 to define a data object type (“Person”) that includes a first property type (“District Name”).

Based on the user operation(s) that result in the interactive graphical representation 1150C, the data extraction system 102 can generate code that specifies a transformation to define a “Person” data object type into the ontology 105 based on the name (“Person”) of the second column of the person table and adding a property type using the name (“District Name”) of the second column of the district table. The code may further specify that the transformation is to add data objects into the database 109, where the data objects will be generated based on one or more rules defined by the user 150. For example, the transformation may be stored as the code, when executed by the data extraction system 102, that generates one or more “Person” data objects including one or more district name properties based on connections between the third (e.g., “Supervisor Person”) columns of the district table and the second (e.g. “Person”) column of the person table.

FIG. 11D illustrates data objects that may be added to the database 109 after a transformation and/or the ontology 105 is applied to the tabular data shown in FIG. 11A. As shown in FIG. 11D, a “Person” data object (e.g., “John”) that has two district name properties (e.g., “Zone X” and “Zone Y”) and a “Person” data object (e.g., “Sam”) that has a district name property (e.g., “Zone Z”) are stored in the database 109.

### Additional Example Implementations and Details

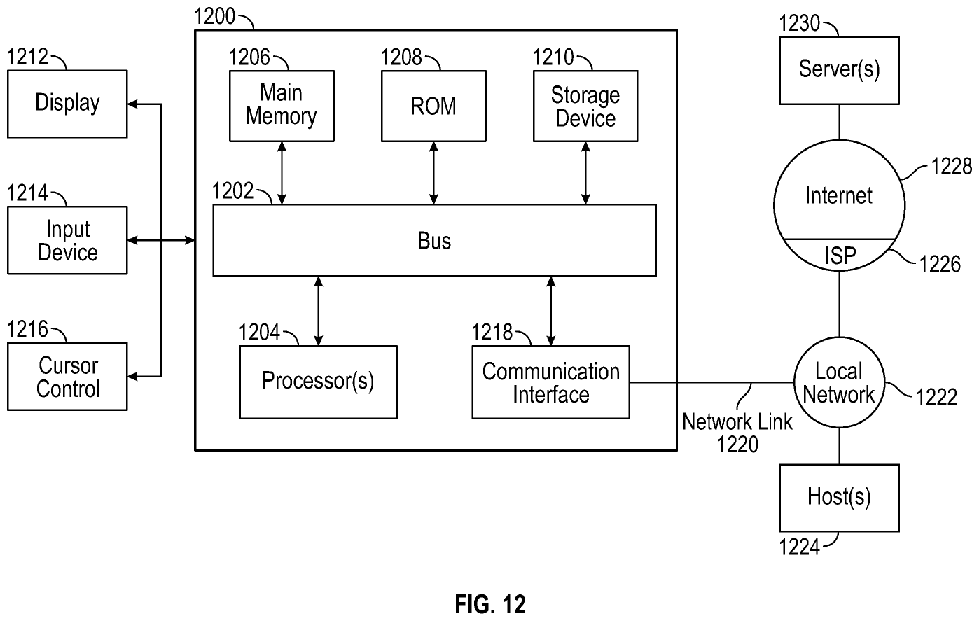

In an implementation of the system (e.g., one or more aspects of the data extraction system 102, one or more aspects of the computing environment 100, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 12) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In various implementations the virtual computing environment may comprise one or more virtual machines, containers, and/or other types of emulations of computing systems or environments. In various implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In various alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in various implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, Vx Works, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 12 shows a block diagram that illustrates a computer system 1200 upon which various implementations and/or aspects (e.g., one or more aspects of the computing environment 100, one or more aspects of the data extraction system 102, one or more aspects of the user 150, one or more aspects of the tabular data source 120, one or more aspects of the LLMs 130a and 130b, and/or the like) may be implemented. Multiple such computer systems 1200 may be used in various implementations of the present disclosure. Computer system 1200 includes a bus 1202 or other communication mechanism for communicating information, and a hardware processor, or multiple processors, 1204 coupled with bus 1202 for processing information. Hardware processor(s) 1204 may be, for example, one or more general purpose microprocessors.

Computer system 1200 also includes a main memory 1206, such as a random-access memory (RAM), cache and/or other dynamic storage devices, coupled to bus 1202 for storing information and instructions to be executed by processor 1204. Main memory 1206 also may be used for storing temporary variables or other intermediate information during execution of instructions to be executed by processor 1204. Such instructions, when stored in storage media accessible to processor 1204, render computer system 1200 into a special-purpose machine that is customized to perform the operations specified in the instructions. The main memory 1206 may, for example, include instructions to implement server instances, queuing modules, memory queues, storage queues, user interfaces, and/or other aspects of functionality of the present disclosure, according to various implementations.

Computer system 1200 further includes a read only memory (ROM) 1208 or other static storage device coupled to bus 1202 for storing static information and instructions for processor 1204. A storage device 1210, such as a magnetic disk, optical disk, or USB thumb drive (Flash drive), and/or the like, is provided and coupled to bus 1202 for storing information and instructions.

Computer system 1200 may be coupled via bus 1202 to a display 1212, such as a cathode ray tube (CRT) or LCD display (or touch screen), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. In various implementations, the same direction information and command selections as cursor control may be implemented via receiving touches on a touch screen without a cursor.

Computer system 1200 may include a user interface module to implement a GUI that may be stored in a mass storage device as computer executable program instructions that are executed by the computing device(s). Computer system 1200 may further, as described below, implement the techniques described herein using customized hard-wired logic, one or more ASICs or FPGAs, firmware and/or program logic which in combination with the computer system causes or programs computer system 1200 to be a special-purpose machine. According to one implementation, the techniques herein are performed by computer system 1200 in response to processor(s) 1204 executing one or more sequences of one or more computer-readable program instructions contained in main memory 1206. Such instructions may be read into main memory 1206 from another storage medium, such as storage device 1210. Execution of the sequences of instructions contained in main memory 1206 causes processor(s) 1204 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1204 for execution. For example, the instructions may initially be carried on a magnetic disk or solid-state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN (or WAN component to communicated with a WAN). Wireless links may also be implemented. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the worldwide packet data communication network now commonly referred to as the “Internet” 1228. Local network 1222 and Internet 1228 both use electrical, electromagnetic, or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computerized method, performed by a computing system having one or more hardware computer processors and one or more computer-readable storage devices storing software instructions executable by the computing system, the computerized method comprising: receiving tabular data from one or more data sources, wherein the tabular data comprises at least a first table and a second table, wherein the first table comprises a first plurality of columns and the second table comprises a second plurality of columns; generating a first prompt for a large language model (“LLM”), the first prompt comprising at least a portion of the first table and at least a portion of the second table; transmitting the first prompt to the LLM; receiving a first output from the LLM in response to the first prompt, the first output comprising at least a first connection between a first column of the first plurality of columns and a first column of the second plurality of columns; providing, via a user interface, an interactive graphical representation comprising at least a first node representing a name of the first column of the first plurality of columns, a second node representing a name of the first column of the second plurality of columns, and a first edge connecting the first node and the second node, the first edge representing the first connection; receiving a first user operation, via the interactive graphical representation of the user interface, to at least the first node; and based at least in part on receiving the first user operation, updating an ontology to include a first data object type corresponding to the name of the first column of the first plurality of columns.

Clause 2. The computerized method of Clause 1, wherein receiving the first user operation comprises receiving an indication that the name of the first column of the first plurality of columns represented by the first node is to be defined in the ontology as the first data object type, and wherein updating the ontology comprises defining the first data object type in the ontology.

Clause 3. The computerized method of any of Claims 1-2 further comprising: based at least in part on updating the ontology to include the first data object type, adding into one or more databases a plurality of first data objects of the first data object type, the plurality of first data objects representing entries of the first column of the first plurality of columns.

Clause 4. The computerized method of any of Clauses 1-3 further comprising: providing, via the interactive graphical representation of the user interface, a third node that represents a name of a second column of the first plurality of columns; receiving a second user operation, made via the interactive graphical representation, associating the third node with the second node; and based at least in part on receiving the second user operation, updating the ontology to include a second data object type corresponding to the name of the first column of the second plurality of columns, and a first property type of the second data object type based on the name of the second column of the first plurality of columns represented by the third node.

Clause 5. The computerized method of any of Clauses 1-4 further comprising: receiving a third user operation, via the interactive graphical representation, disassociating the third node with the second node; and based at least in part on receiving the third user operation, updating the ontology to include the second data object type corresponding to the name of the first column of the second plurality of columns without the first property type of the second data object type, and a third data object type corresponding to the name of the second column of the first plurality of columns.

Clause 6. The computerized method of any of Clauses 1-3 further comprising: providing, via the interactive graphical representation of the user interface, a third node that represents a name of a second column of the first plurality of columns; receiving a fourth user operation, via the interactive graphical representation, associating the third node and the second node with a first entity type, wherein the first entity type is defined by a user; and based at least in part on receiving the fourth user operation, updating the ontology to include: (a) a fourth data object type corresponding to the first entity type, (b) a first property type of the fourth data object type based on the name of the first column of the second plurality of columns represented by the second node, and (c) a second property type of the fourth data object type based on the name of the second column of the first plurality of columns represented by the third node.

Clause 7. The computerized method of Clause 6 further comprising: based at least in part on updating the ontology to include the fourth data object type, adding into one or more databases a plurality of fourth data objects of the fourth data object type, wherein one of the plurality of fourth data objects has a first property of the first property type representing an entry of the first column of the second plurality of columns, and a second property of the second property type representing an entry of the second column of the first plurality of columns.

Clause 8. The computerized method of Clause 7 further comprising: generating the plurality of fourth data objects of the fourth data object type based on one or more rules defined by the user.

Clause 9. The computerized method of Clause 1, wherein: receiving the first user operation comprises: receiving a first indication that the name of the first column of the first plurality of columns represented by the first node is to be defined in the ontology as the first data object type; receiving a second indication that the name of the first column of the second plurality of columns represented by the second node is to be defined in the ontology as a second data object type; and receiving a third indication that the first connection between the first column of the first plurality of columns and the first column of the second plurality of columns represented by the first edge is to be defined in the ontology as a link type between the first data object type and the second data object type; and updating the ontology comprises: defining the first data object type, the second data object type, and the link type in the ontology.

Clause 10. The computerized method of any of Clause 1-9 further comprising: providing, via the interactive graphical representation of the user interface, a fourth node that represents a second entity type corresponding to a fifth data object type defined in the ontology.

Clause 11. The computerized method of any of Clause 1-10 further comprising: vectorizing the first column of the first plurality of columns into a first vector; vectorizing the first column of the second plurality of columns into a second vector; and executing, using at least the first vector and the second vector, a similarity search to establish the first connection between the first column of the first plurality of columns and the first column of the second plurality of columns are related to each other.

Clause 12. The computerized method of any of Clauses 1-11 wherein the interactive graphical representation comprises a fifth node, a sixth node, and a second edge connecting the fifth node and the sixth node, and wherein: the fifth node represents a name of a third column of the first plurality of columns, the sixth node represents a name of a fourth column of the first plurality of columns, and the second edge represents a second connection between the third column of the first plurality of columns and the fourth column of the first plurality of columns.

Clause 13. The computerized method of Clause 12, wherein information contained in the first table is indicative of the second connection.

Clause 14. The computerized method of any of Clauses 1-13, wherein the tabular data comprises a plurality of tables, and wherein the interactive graphical representation comprises a plurality sets of nodes, each of the plurality sets of nodes corresponding to each of the plurality of tables.

Clause 15. The computerized method of Clauses 14, wherein nodes of each respective set of nodes are visually similar, and wherein nodes of different sets of nodes are visually distinctive.

Clause 16. The computerized method of any of Clauses 1-15, wherein the portion of the first table includes names of the first plurality of columns and the portion of the second table includes names of the second plurality of columns.

Clause 17. The computerized method of any of Clauses 1-16, wherein the ontology is defined by one or more transformations that transform at least the portion of the first table and the portion of the second table to one or more data object types.

Clause 18. The computerized method of Clause 17 wherein the one or more transformations are stored in one or more databases as code that specifies the one or more transformations.

Clause 19. A system comprising: one or more computer-readable storage mediums having program instructions embodied therewith; and one or more processors configured to execute the program instructions to cause the system to perform the computerized method of any of Clauses 1-18.

Clause 20. A computer program product comprising one or more computer-readable storage mediums having program instructions embodied therewith, the program instructions executable by one or more processors to cause the one or more processors to perform the computerized method of any of Clauses 1-18.

What is claimed is:

1. A computerized method, performed by a computing system having one or more hardware computer processors and one or more computer-readable storage devices storing software instructions executable by the computing system, the computerized method comprising:
receiving tabular data from one or more data sources, wherein the tabular data comprises at least a first table and a second table, wherein the first table comprises a first plurality of columns and the second table comprises a second plurality of columns;
generating a first prompt for a large language model (“LLM”), the first prompt comprising at least a portion of the first table and at least a portion of the second table;
transmitting the first prompt to the LLM;
receiving a first output from the LLM in response to the first prompt, the first output comprising at least a first connection between a first column of the first plurality of columns and a first column of the second plurality of columns;
providing, via a user interface, an interactive graphical representation comprising at least a first node representing a name of the first column of the first plurality of columns, a second node representing a name of the first column of the second plurality of columns, and a first edge connecting the first node and the second node, the first edge representing the first connection;
receiving a first user operation, via the interactive graphical representation of the user interface, to at least the first node; and
based at least in part on receiving the first user operation, updating an ontology to include a first data object type corresponding to the name of the first column of the first plurality of columns.

2. The computerized method of claim 1, wherein receiving the first user operation comprises receiving an indication that the name of the first column of the first plurality of columns represented by the first node is to be defined in the ontology as the first data object type, and wherein updating the ontology comprises defining the first data object type in the ontology.

3. The computerized method of claim 1 further comprising:
based at least in part on updating the ontology to include the first data object type, adding into one or more databases a plurality of first data objects of the first data object type, the plurality of first data objects representing entries of the first column of the first plurality of columns.

4. The computerized method of claim 1 further comprising:
providing, via the interactive graphical representation of the user interface, a third node that represents a name of a second column of the first plurality of columns;
receiving a second user operation, made via the interactive graphical representation, associating the third node with the second node; and
based at least in part on receiving the second user operation, updating the ontology to include a second data object type corresponding to the name of the first column of the second plurality of columns, and a first property type of the second data object type based on the name of the second column of the first plurality of columns represented by the third node.

5. The computerized method of claim 4 further comprising:
receiving a third user operation, via the interactive graphical representation, disassociating the third node with the second node; and
based at least in part on receiving the third user operation, updating the ontology to include the second data object type corresponding to the name of the first column of the second plurality of columns without the first property type of the second data object type, and a third data object type corresponding to the name of the second column of the first plurality of columns.

6. The computerized method of claim 1 further comprising:
providing, via the interactive graphical representation of the user interface, a third node that represents a name of a second column of the first plurality of columns;
receiving a fourth user operation, via the interactive graphical representation, associating the third node and the second node with a first entity type, wherein the first entity type is defined by a user; and
based at least in part on receiving the fourth user operation, updating the ontology to include: (a) a fourth data object type corresponding to the first entity type, (b) a first property type of the fourth data object type based on the name of the first column of the second plurality of columns represented by the second node, and (c) a second property type of the fourth data object type based on the name of the second column of the first plurality of columns represented by the third node.

7. The computerized method of claim 6 further comprising:
based at least in part on updating the ontology to include the fourth data object type, adding into one or more databases a plurality of fourth data objects of the fourth data object type,
wherein one of the plurality of fourth data objects has a first property of the first property type representing an entry of the first column of the second plurality of columns, and a second property of the second property type representing an entry of the second column of the first plurality of columns.

8. The computerized method of claim 7 further comprising:
generating the plurality of fourth data objects of the fourth data object type based on one or more rules defined by the user.

9. The computerized method of claim 1, wherein:
receiving the first user operation comprises:
receiving a first indication that the name of the first column of the first plurality of columns represented by the first node is to be defined in the ontology as the first data object type;
receiving a second indication that the name of the first column of the second plurality of columns represented by the second node is to be defined in the ontology as a second data object type; and
receiving a third indication that the first connection between the first column of the first plurality of columns and the first column of the second plurality of columns represented by the first edge is to be defined in the ontology as a link type between the first data object type and the second data object type; and
updating the ontology comprises:
defining the first data object type, the second data object type, and the link type in the ontology.

10. The computerized method of claim 1 further comprising:
providing, via the interactive graphical representation of the user interface, a fourth node that represents a second entity type corresponding to a fifth data object type defined in the ontology.

11. The computerized method of claim 1 further comprising:
vectorizing the first column of the first plurality of columns into a first vector;
vectorizing the first column of the second plurality of columns into a second vector; and
executing, using at least the first vector and the second vector, a similarity search to establish the first connection between the first column of the first plurality of columns and the first column of the second plurality of columns are related to each other.

12. The computerized method of claim 1, wherein the interactive graphical representation comprises a fifth node, a sixth node, and a second edge connecting the fifth node and the sixth node, and wherein:
the fifth node represents a name of a third column of the first plurality of columns, the sixth node represents a name of a fourth column of the first plurality of columns, and the second edge represents a second connection between the third column of the first plurality of columns and the fourth column of the first plurality of columns.

13. The computerized method of claim 12, wherein information contained in the first table is indicative of the second connection.

14. The computerized method of claim 1, wherein the tabular data comprises a plurality of tables, and wherein the interactive graphical representation comprises a plurality sets of nodes, each of the plurality sets of nodes corresponding to each of the plurality of tables.

15. The computerized method of claim 14, wherein nodes of each respective set of nodes are visually similar, and wherein nodes of different sets of nodes are visually distinctive.

16. The computerized method of claim 1, wherein the portion of the first table includes names of the first plurality of columns and the portion of the second table includes names of the second plurality of columns.

17. The computerized method of claim 1, wherein the ontology is defined by one or more transformations that transform at least the portion of the first table and the portion of the second table to one or more data object types.

18. The computerized method of claim 17, wherein the one or more transformations are stored in one or more databases as code that specifies the one or more transformations.

19. A system comprising:
one or more computer-readable storage mediums having program instructions embodied therewith; and
one or more processors configured to execute the program instructions to cause the system to perform the computerized method of claim 1.

20. A computer program product comprising one or more computer-readable storage mediums having program instructions embodied therewith, the program instructions executable by one or more processors to cause the one or more processors to perform the computerized method of claim 1.
